(19) United States
(12) Patent Application Publication
(10) Pub. No.: US 2011/0223502 A1
(43) Pub. Date: Sep. 15, 2011

(54) Fuel Reforming Apparatus And Fuel Cell System

(75) Inventor: Takao Maruyama, Kanagawa-ken (JP)

(73) Assignee: NISSAN MOTOR CO., LTD.

(21) Appl. No.: 10/527,060

(22) PCT Filed: Oct. 23, 2003
(86) PCT No.: PCT/JP03/13566

§ 371 Date: Mar. 9, 2005

(30) Foreign Application Priority Data
Mar. 12, 2002 (JP) 2002-351013
Oct. 23, 2002 (JP) 2002-308364
Dec. 3, 2002 (JP) 2002-351014
Sep. 3, 2003 (JP) 2003-311883

(51) Int. Cl. H01M 8/06; B01J 8/04

(52) U.S. Cl. 429/420; 422/631; 422/634

(57) ABSTRACT

A fuel reforming apparatus includes a catalyst packed portion containing therein fuel reforming catalyst (I) having excellent hydrocarbon conversion rate and fuel reforming catalyst (II) having excellent H₂+CO formation rate. Each of catalyst (I) and catalyst (II) especially preferably includes rhodium supported thereon. When the carrier for catalyst (I) is aluminum oxide and the carrier for catalyst (II) is cerium oxide, the hydrogen generation efficiency is excellent particularly even at start-up.

### TECHNICAL FIELD

The present invention relates to a fuel reforming apparatus which reforms hydrocarbon gas to obtain hydrogen gas, and a fuel cell system using the fuel reforming apparatus, a hydrogen generating apparatus, and a vehicle having the system mounted thereon.

### BACKGROUND ART

A polymer electrolyte fuel cell can achieve high current density even at relatively low temperatures, and is expected as a mobile power source for vehicle. As a hydrogen source for the polymer electrolyte fuel cell, a system utilizing pure hydrogen is mainly studied. This system requires no consideration for the effect of carbon monoxide on the polymer electrolyte fuel cell, and can offer a simple construction.

Further, there is a system using hydrocarbon as a hydrogen source. For example, a system using a hydrocarbon reforming catalyst comprising a catalyst which comprises at least one element selected from the group consisting of titanium, aluminum, silicon, zirconium, nickel, iron, cobalt, copper, zinc, platinum, palladium, ruthenium, and rhodium, and a metal honeycomb substrate coated with the catalyst is disclosed in Japanese Patent Application Laid-open No. 2000-126595. In this patent document, the method, in which hydrogen is obtained through a catalyst reaction by supplying water or oxygen to hydrocarbon, is accompanied by heating or heat generation and hence, for facilitating the control of heat transfer, the reforming catalyst comprising the above catalyst component and a metal honeycomb substrate coated with the catalyst component is prepared.

### DISCLOSURE OF INVENTION

The system using hydrocarbon as a hydrogen source has an advantage in that the raw material is easily available and inexpensive. However, the system may exhibit only poor reforming properties at start-up. Specifically, the system is at a low temperature immediately after starting up the system and hence the catalytic activity is low, and the unreacted hydrocarbon may remain or the concentration of hydrogen or carbon monoxide in the reformed gas cannot reach the equilibrium composition in a steady state. The fuel reforming system can be mounted on a fuel cell car, but it has unsatisfactory starting-up properties for the use in vehicle requiring excellent starting-up properties.

The present inventor has made close studies on the properties of the reforming catalyst. As a result, they have paid attention to the fact that the reforming reaction of hydrocarbon consists of a hydrocarbon decomposition reaction which decomposes hydrocarbon into CHₓ and a steam reforming reaction which forms carbon monoxide and hydrogen. Further, they have found that a combination of a catalyst having excellent hydrocarbon decomposition performance and a catalyst having such excellent steam reforming performance that H₂O is activated to facilitate steam reforming can improve the reforming efficiency. Furthermore, they have confirmed that, when a catalyst packed portion of a fuel reforming apparatus contains therein a fuel reforming catalyst (I) having excellent hydrocarbon conversion rate and a fuel reforming catalyst (II) having excellent H₂+CO formation rate, excellent starting-up properties even under conditions at low temperatures and improved robustness can be obtained, and the present invention has been completed.

Specifically, the present invention provides a fuel reforming apparatus which comprises a catalyst packed portion containing therein a fuel reforming catalyst (I) having excellent hydrocarbon conversion rate and a fuel reforming catalyst (II) having excellent H₂+CO formation rate.

In addition, the present invention provides a polymer electrolyte fuel cell system which comprises the above fuel reforming apparatus, a shift reactor for reducing carbon monoxide contained in the discharged gas from the apparatus through a water-gas-shift reaction, a carbon monoxide removing apparatus for removing carbon monoxide contained in the discharged gas from the shift reactor, and a polymer electrolyte fuel cell.

Further, the present invention provides a fuel reforming-type hydrogen generating system, a fuel cell system, and a fuel reforming-type fuel cell vehicle, each having the above fuel reforming apparatus mounted thereon.

In the present invention, the catalyst packed portion of the reforming apparatus contains therein fuel reforming catalyst (I) having excellent hydrocarbon conversion rate and fuel reforming catalyst (II) having excellent H₂+CO formation rate, and therefore the amount of hydrogen gas and carbon monoxide gas can be maximized even at low temperatures, thus improving the starting-up properties and the robustness. Especially when aluminum oxide is used as a carrier for catalyst (I) and cerium oxide is used as a carrier for catalyst (II), and each of catalyst (I) and catalyst (II) comprises at least one noble metal element selected from platinum, rhodium, palladium, and ruthenium supported on the carrier, hydrogen gas can be generated more efficiently than when using solely catalyst (I) or catalyst (II).

In addition, in the fuel reforming apparatus of the present invention, reforming catalysts having different properties are used in the catalyst packed portion, and therefore hydrogen gas can be generated more efficiently in both a low temperature region and a high temperature region than when using solely catalyst (I) or catalyst (II).

In the present invention, especially when catalyst (I) and catalyst (II) are used in the form of a mixture or a stacked structure comprising a surface layer comprising catalyst (I) and an inner layer comprising catalyst (II), heat generated in the exothermic reaction proceeding on catalyst (I) can be effectively utilized in the endothermic reaction proceeding on catalyst (II), and therefore hydrogen can be extremely efficiently supplied without lowering the catalytic activity in the range of from a low SV (space velocity) region to a high SV region, i.e., about 15 to 35.

The reforming apparatus of the present invention can exhibit excellent effect on raw material supply gas, such as isooctane or desulfurized gasoline.

### BRIEF DESCRIPTION OF DRAWINGS

FIG. 1 is a view showing the construction of a polymer electrolyte fuel cell system including cooling means;

FIG. 2 is a graph showing the hydrocarbon conversion rate of each of the reaction using solely catalyst (I) (Rh/Al₂O₃) comprising Rh and an Al₂O₃ carrier having Rh supported thereon, the reaction using solely catalyst (II) (Rh/CeO₂) comprising Rh and a CeO₂ carrier having Rh supported thereon, and the reaction using a mixture of catalyst (I) and catalyst (II) (Reaction Example 11);

FIG. 3 is a graph showing the H₂+CO formation rate obtained when using solely Rh/Al₂O₃ catalyst (I), that obtained when using solely Rh/CeO₂ catalyst (II), and that obtained when using a mixture of catalyst (I) and catalyst (II);

FIG. 4 is a graph showing the hydrocarbon conversion rate obtained when using solely Rh/Al₂O₃ catalyst (I) coated on a honeycomb substrate, that obtained when using solely Rh/CeO₂ catalyst (II) coated on a honeycomb substrate, and that obtained when using catalyst (I) and catalyst (II) wherein catalyst (II) is coated on a honeycomb substrate and catalyst (I) is stacked on catalyst (II); and

FIG. 5 is a graph showing the H₂+CO formation rate obtained when using solely Rh/Al₂O₃ catalyst (I), that obtained when using solely Rh/CeO₂ catalyst (II), and that obtained when using catalyst (I) and catalyst (II) wherein catalyst (II) is coated and catalyst (I) is stacked on catalyst (II).

### BEST MODE FOR CARRYING OUT THE INVENTION

### First Embodiment

The first embodiment of the present invention is directed to a fuel reforming apparatus. The fuel reforming apparatus is an apparatus which reforms hydrocarbon contained in a fuel to form hydrogen, and has a catalyst packed portion which is a reaction tube packed with a catalyst. The catalyst packed portion has one feed inlet or a plurality of feed inlets for feeding at least fuel gas, oxidizing gas required for a reforming reaction, such as air, and steam gas, and a discharge outlet for discharging the reformed gas. The fuel reforming apparatus according to the first embodiment of the present invention has a characteristic feature such that the catalyst packed portion contains therein fuel reforming catalyst (I) having excellent hydrocarbon conversion rate and fuel reforming catalyst (II) having excellent H₂+CO formation rate.

In the reforming reaction of hydrocarbon on a fuel reforming catalyst, when, for example, isooctane C₈H₁₈ [(CH₃(CH₃)₂CCH₂(CH₃)CHCH₃)] is used as a fuel, it is considered that hydrocarbon decomposition reaction (i) shown below advanced by addition of oxygen and steam proceeds simultaneously with oxidizing and steam reforming reactions (ii) represented by (a) to (d) below for CH₄ obtained in the above reaction.

Hydrocarbon decomposition reaction (i):

2C₈H₁₈+7/2O₂=9CH₄+7CO

Oxidizing/steam reforming reactions (ii):

CH₄+H₂O→CO+3H₂ (a)

CH₄+CO₂→2CO+2H₂ (b)

CH₄+½O₂→CO+2H₂ (c)

CH₄+2O₂→CO₂+2H₂O (d)

In addition, in the reforming reaction of hydrocarbon, it is considered that the following exothermic reactions and endothermic reactions proceed.

General reactions:

C₈H₁₈+8O₂→8CO₂+8H₂ Exothermic reaction (1)

C₈G₁₈+16H₂O→8CO₂+25O₂ Endothermic reaction (2)

Side reactions:

C₈H₁₈→C_{1 to 7}H_{1 to 18}→CH_{X} Exothermic reaction (3)

CO₂+H₂⇄CO+H₂O Endothermic reaction (4)

CO+3H₂⇄CH₄+H₂O Endothermic reaction (5)

In the hydrocarbon decomposition reaction, exothermic reactions (1) and (3) proceed, and especially the amount of heat generated by exothermic reaction (1) is large. On the other hand, in the steam reforming reaction, endothermic reactions (2), (4), and (5) proceed.

With respect to the reforming catalyst conventionally used, one type of a catalyst having both hydrocarbon decomposition performance and steam reforming performance is generally used, and the composition of the catalyst determines whether the catalyst exhibits more remarkably any one of these properties. However, conventionally, without taking into consideration the properties of the individual catalysts in the reforming reaction, the composition of the raw material gas fed to the reforming apparatus and the composition of the reformed gas discharged from the reforming apparatus have been compared to evaluate the reforming efficiency.

In the present invention, the reforming reaction has been closely analyzed. As a result, at least two types of reforming catalysts, i.e., fuel reforming catalyst (I) having excellent hydrocarbon conversion rate and fuel reforming catalyst (II) having excellent H₂+CO formation rate are contained in the reforming catalyst packed portion in the reforming apparatus, and the rapid hydrocarbon decomposition reaction catalyzed by catalyst (I) and the efficient steam reforming performance of catalyst (II) can achieve high reforming rate even at start-up at low temperatures, making it possible to supply a large amount of hydrogen.

Conventionally, the catalytic activity is unsatisfactory at low temperatures, and hence satisfactory hydrocarbon decomposition performance for raw material gas cannot be obtained, so that the unreacted hydrocarbon may remain, making the reaction system difficult to reach the equilibrium composition. However, in the fuel reforming apparatus of the present invention, the catalyst packed portion containing therein two types of reforming catalysts having different properties has solved the problem.

In the present invention, the “hydrocarbon conversion rate” is determined by making calculation in accordance with the following (Formula 1):

$$Hydrocarbon conversion rate ( \% ) = \frac{\begin{matrix}( Hydrocarbon concentration at inlet ) - \\ ( Hydrocarbon concentration at outlet )\end{matrix}}{( Hydrocarbon concentration at inlet )} \times 100 \qquad ( Formula 1 )$$

The term “excellent hydrocarbon conversion rate” means that a catalyst can exhibit a hydrocarbon conversion rate of 60% or more, as measured in accordance with the method described in Examples shown below, for example, at a temperature of 400° C. or higher. Specifically The term “excellent hydrocarbon conversion rate” means that a catalyst has a hydrocarbon conversion rate of 80% or more, preferably 85 to 100%, more preferably 90 to 100% at an outlet temperature of the catalyst packed portion of 587° C. Further, the “hydrocarbon conversion rate” obtained when using desulfurized gasoline as a fuel means a “desulfurized gasoline conversion rate” determined by the following formula 2:

$$Desulfurized gasoline conversion rate ( \% ) = \frac{\begin{matrix}( carbon content at inlet ) - \\ ( carbon content at outlet )\end{matrix}}{( carbon content at inlet )} \times 100 \qquad ( Formula 2 )$$

Specifically, the catalyst having “excellent hydrocarbon conversion rate” when using desulfurized gasoline as a fuel means a catalyst having a desulfurized gasoline conversion rate of 80% or more, preferably 85 to 100%, more preferably 90 to 100% at an inlet temperature of 500° C. (LHSV=25).

The term “H₂+CO formation rate” means the sum of a hydrogen concentration of the whole gas and a carbon monoxide concentration of the whole gas, or a value obtained by dividing the sum of a hydrogen concentration of the whole gas and a carbon monoxide concentration of the whole gas by a nitrogen concentration. The term “excellent H₂+CO formation rate” means that a catalyst can exhibit an H₂+CO formation rate of 20% or more, as measured in accordance with the method described in Examples shown below, for example, at a temperature of 400° C. or higher. Specifically, the term “excellent H₂+CO formation rate” means that, when reforming isooctane, a catalyst has an H₂+CO formation rate of 30% or more, preferably 31 to 35%, more preferably 31 to 33% at an outlet temperature of 587° C. Further, the term “excellent H₂+CO formation rate” means that, when reforming desulfurized gasoline, a catalyst has an H₂+CO formation rate of 1.25% or more, preferably 1.29% or more at an inlet temperature of 400° C.

Catalyst (I) and catalyst (II) have a relationship such that, at an operating temperature of from 300 to 800° C., the “hydrocarbon conversion rate” of catalyst (I) is higher than that of catalyst (II) and the “H₂+CO formation rate” of catalyst (II) is higher than that of catalyst (I).

Hereinbelow, the present invention will be described in detail.

The fuel reforming apparatus of the present invention has at least a catalyst packed portion filled with a reforming catalyst, and additionally has a raw material feed inlet, a feed inlet for oxygen or molecular oxygen-containing gas, such as air, and a steam feed inlet. The mixed gas temperature is generally −30 to 50° C. at start-up when feeding raw material gas to the catalyst packed portion, together with steam or molecular oxygen-containing gas. The raw material gas is decomposed into CHₓ by the reforming catalyst, and this reaction is an exothermic reaction and the temperature at an outlet of the catalyst packed portion generally reaches 300 to 800° C.

In the reforming apparatus, the catalyst packed portion to be filled with a reforming catalyst contains therein fuel reforming catalyst (I) having excellent hydrocarbon conversion rate and fuel reforming catalyst (II) having excellent H₂+CO formation rate. More preferred are the following arrangements (A) to (C) for the catalysts.

(A) The catalyst packed portion is considered to be comprised of a raw material feed side and a discharged gas outlet side, and catalyst (I) having excellent hydrocarbon conversion rate even under conditions such that the temperature of the gas fed is low is contained in a front section of the apparatus (raw material feed side) and catalyst (II) having high H₂+CO formation rate is contained in a back section of the apparatus (discharge outlet side).

(B) Taking into consideration the fact that a reforming catalyst is generally used in the form of being supported on, for example, a honeycomb substrate, a layer of catalyst supported on, for example, a honeycomb substrate is constituted by a mixture of catalyst (I) having excellent hydrocarbon conversion rate even under conditions such that the temperature of the gas fed is low and catalyst (II) having high H₂+CO formation rate.

(C) Taking into consideration the fact that a reforming catalyst is generally used in the form of being supported on, for example, a honeycomb substrate, a layer of catalyst supported on, for example, a honeycomb substrate is constituted by two layers, i.e., a surface layer and an inner layer wherein the surface layer is comprised of catalyst (I) having excellent hydrocarbon conversion rate even under conditions such that the temperature of the gas fed is low and the inner layer is comprised of catalyst (II) having high H₂+CO formation rate.

By employing the arrangements (A) to (C), more excellent reforming rate can be achieved advantageously even at start-up at low temperatures, making it possible to supply a large amount of hydrogen.

Specifically, when the arrangement (A) is employed, the hydrocarbon decomposition reaction is efficiently promoted in the front section of the catalyst packed portion. On the other hand, the steam reforming reaction for CHₓ obtained in the hydrocarbon decomposition reaction in the front section can be more efficiently promoted in the back section due to the steam activation function of catalyst (II), so that the hydrocarbon is prevented from remaining unreacted, thus improving the fuel reforming efficiency.

When the arrangement (B) is employed, the hydrocarbon decomposition reaction promoted mainly by catalyst (I) is an exothermic reaction and the steam reforming reaction promoted mainly by catalyst (II) is an endothermic reaction, and the exothermic reaction and the endothermic reaction proceed in the places adjacent to each other, and therefore heat of reaction obtained in the exothermic reaction is effectively utilized in the endothermic reaction without rendering the heat useless, so that the steam reforming reaction can be more efficiently advanced, thus improving the fuel reforming efficiency.

When the arrangement (C) is employed, the hydrocarbon decomposition reaction promoted mainly by catalyst (I), which is an exothermic reaction, and the oxidizing or steam reforming reaction promoted mainly by catalyst (II), which is an endothermic reaction, proceed in the places adjacent to each other, and therefore heat of reaction obtained in the exothermic reaction can be effectively utilized in the steam reforming reaction without rendering the heat useless. Further, the surface layer is comprised of catalyst (I) and hence, the gas obtained by first satisfactorily decomposing the fuel gas into CHₓ through the hydrocarbon decomposition reaction is diffused and reaches catalyst (II) in the inner layer where the oxidizing or steam reforming reaction is promoted, thus improving the fuel reforming efficiency.

As examples of catalyst (I) and (II) used in the present invention, there can be mentioned ones obtained by supporting on a carrier at least one noble metal element selected from platinum, rhodium, palladium, and ruthenium, especially preferably rhodium or ruthenium, and baking it. The noble metal element is advantageously used in a steam reforming reaction (for example, CH₄+H₂O→CO+3H₂), and especially preferred is rhodium having excellent durability and excellent catalytic activity.

With respect to catalyst (I) and catalyst (II), the amount of the noble metal element supported may be 0.1 to 10% by mass, more preferably 0.5 to 4% by mass per catalyst in terms of a metal. When the amount of the noble metal element supported falls in the above range, the dispersibility of the noble metal element on a carrier is excellent, so that high catalytic activity can be secured.

As a carrier for catalyst (I), aluminum oxide, zirconium oxide, titanium oxide, silicon oxide, cerium oxide, or cerium-zirconium composite oxide can be used, and aluminum oxide, zirconium oxide, and/or titanium oxide is preferably used. When a noble metal element is supported on the oxide, the resultant catalyst has excellent hydrocarbon conversion rate in a low temperature region of 550 to 650° C., so that a high feed rate of CHₓ can be secured even in a low temperature region. Especially, aluminum oxide having a large BET specific surface area can have supported thereon a noble metal in a larger amount, and has excellent dispersibility for the noble metal catalyst, and hence is excellent in hydrocarbon decomposition promoting function.

On the other hand, examples of carriers for catalyst (II) include cerium oxide and/or cerium-zirconium composite oxide, and zirconium oxide, and a carrier comprising cerium oxide having a function of activating steam to promote the steam reforming reaction is preferably used. Therefore, preferred is cerium oxide and/or cerium-zirconium composite oxide. When a noble metal element is supported on the oxide, the resultant catalyst has excellent steam reforming performance even in a low temperature region of 550 to 650° C., a high feed rate of hydrogen and carbon monoxide can be secured even in a low temperature region.

It is preferred that aluminum oxide is used as a carrier for catalyst (I) and cerium oxide is used as a carrier for catalyst (II). The carrier preferably has a BET specific surface area of 10 to 300 m²/g, more preferably 40 to 300 m²/g. The carrier preferably has an average particle size of 0.1 to 50 μm, more preferably 0.1 to 3 μm.

Catalyst (I) and catalyst (II) in the present invention can be prepared using a catalyst preparation solution containing a noble metal element to be supported on the carrier, and using a conventionally known technique, such as an impregnation method, a coprecipitation method, or a competitive adsorption method. The conditions for the treatment can be appropriately selected depending on the type of method, and, generally, the carrier and the catalyst preparation solution are brought into contact with each other at 20 to 90° C. for one minute to 10 hours. For example, the carrier may be impregnated with a catalyst preparation solution having dissolved or dispersed therein a compound comprising the above-mentioned noble metal element, and dried and baked to obtain a baked product. In such a solution, water, or a wide variety of solvents which can dissolve the compound comprising the above element, for example an alcohol, such as methanol or ethanol, an ether, such as diethyl ether, or a carboxylic acid can be used.

Then, the carrier is dried, and, in the drying method, for example, natural drying, evaporation to dryness, or drying by means of a rotary evaporator, a spray dryer, or a drum dryer can be employed. After the treatment, the resultant product is baked. The baking temperature may be 200 to 1000° C., and the baking time may be 30 to 480 minutes.

Catalyst (I) and catalyst (II) used in the present invention may comprise the noble metal and further at least one element selected from manganese, iron, cobalt, nickel, and copper (hereinafter referred to also as “additional second component”), and the carrier having them supported thereon. Addition of the additional component improves the hydrocarbon conversion rate and/or the H₂+CO formation rate. The amount of the additional component supported is preferably 0.1 to 20% by mass, more preferably 0.5 to 5% by mass, based on the mass of the catalyst. The additional component may be supported on the carrier either simultaneously with supporting the noble metal element or separately. When the noble metal element is separately supported on the carrier, the carrier having the additional component supported thereon may be impregnated with a solvent having dissolved or dispersed therein a compound comprising the noble metal element and then baked. Not only an impregnation method but also another conventionally known technique, such as, a coprecipitation method or a competitive adsorption method, can be used.

Catalyst (I) and catalyst (II) in the present invention may further comprise an alkali metal, an alkaline earth metal, a rare earth element, or a transition element.

As an alkali metal, preferred is sodium, potassium, rubidium, or cesium, and, as an alkaline earth metal, preferred is magnesium, calcium, strontium, or barium. As a rare earth element, preferred is lanthanum, cerium, praseodymium, or neodymium, and, as a transition element, preferred is manganese, iron, cobalt, nickel, or copper. With respect to the amount of the additive supported, there is no particular limitation, but changing the amount of the additive can control the hydrocarbon conversion rate or the H₂+CO formation rate, and therefore it is desired that the amount of the additive supported is selected so as to obtain desired properties. Basically, when the amount of the additive supported is 0.1 to 20% by mass, based on the catalyst, control can be made. This component may be supported on the carrier either simultaneously with supporting the noble metal element or additional component or separately.

When catalyst (I) and catalyst (II) in the present invention, which are in an indefinite form, such as a powdery form or a granular form, are contained in the catalyst packed portion in the arrangement (A), for example, a net comprised of a material having excellent heat resistance and excellent gas permeability may be placed in the catalyst packed portion in the fuel reforming apparatus so that the individual catalysts are not mixed with each other. When the catalysts are contained in the catalyst packed portion in the arrangement (B), merely a mixture of catalyst (I) and catalyst (II) may be prepared and used as a catalyst composition. Further, when the catalysts are contained in the catalyst packed portion in the arrangement (C), catalyst (II) may be merely impregnated or coated with catalyst (I) to form a coated layer, making a two-layer coat catalyst.

In the present invention, it is preferred that each catalyst is in the form of a monolith catalyst comprising a honeycomb substrate or a porous substrate having the catalyst supported thereon. When each catalyst is a monolith catalyst, the catalyst packed portion in the reforming apparatus is easily filled with the catalyst. The honeycomb structure or porous structure secures permeability to the raw material gas or reformed gas. In addition, the catalyst can be protected from heat or baking during feeding of the raw material gas, so that the catalyst life and the catalytic activity can be improved.

A material for the honeycomb substrate may be ceramic or a metal, and, for example, as a ceramic honeycomb substrate (cerahoneycomb), a substrate having 400 to 3000 cells and a diameter of 35 mmΦ can be used.

On the other hand, as a porous substrate, a porous substrate made of a metal processed into a foam (metal foam) or a porous substrate made of ceramic processed into a foam (cerafoam) can be used. As a metal foam, one made of Ni—Cr having a pore diameter in the range of 20 to 50 pores/inch and having a diameter of 100 mmΦ can be used, and, as a cerafoam, one having a pore diameter of 9 to 30 pores/inch and having a diameter of 75 mmΦ can be used. A cerahoneycomb, a metal foam, and a cerafoam are preferred since they are excellent in pressure loss and the coating technique for them is easy. For securing the gas permeability or catalytic activity, it is preferred that the honeycomb substrate has a cell width of 0.01 to 10 mm and has 100 to 10000 cells per liter.

For supporting the catalyst on a honeycomb substrate or a porous substrate (hereinafter, referred to as “honeycomb substrate or the like”), for example, an element to be a carrier for catalyst (I) or catalyst (II), such as titanium, zirconium, vanadium, aluminum, or cerium, is deposited onto the honeycomb substrate or the like by, for example, impregnation, and the honeycomb substrate or the like is baked, and then at least one element selected from platinum, rhodium, palladium, and ruthenium is supported on the baked product, thus producing a catalyst.

When the catalysts are individually contained in the front section and the back section like the arrangement (A), catalyst (I) and catalyst (II) are preliminarily prepared, and the catalysts are individually stirred in water in an amount 1 to 10 times the amount of each catalyst and ground to prepare a catalyst (I) slurry and a catalyst (II) slurry, and each slurry is applied to the honeycomb substrate or the like, and the honeycomb substrate or the like is dried and baked, thus producing catalysts. In this case, the honeycomb substrate or the like may be prepared respectively for catalyst (I) and for catalyst (II), or catalyst (I) may be applied to the front section of one honeycomb substrate or the like, and catalyst (II) may be applied to the back section, and dried and baked.

Further, when the catalysts are contained in the form of a mixture like the arrangement (B), catalyst (I) and catalyst (II) are preliminarily prepared, and the catalysts are individually stirred in water in an amount 1 to 10 times the amount of each catalyst and ground to prepare a catalyst (I) slurry and a catalyst (II) slurry, and a mixed slurry of the catalyst (I) slurry and the catalyst (II) slurry is applied to the honeycomb substrate or the like, and the honeycomb substrate or the like is dried and baked, thus producing catalysts.

Further, when the catalysts are contained in the form of a two-layer coat catalyst like arrangement (C), catalyst (I) and catalyst (II) are preliminarily prepared, and the catalysts are individually stirred in water in an amount 1 to 10 times the amount of each catalyst and ground to prepare a catalyst (I) slurry and a catalyst (II) slurry, and catalyst (II) as an inner layer catalyst is first applied to the honeycomb substrate or the like and the honeycomb substrate or the like is dried and baked, and then catalyst (I) as a surface layer catalyst is applied to the inner layer, and the honeycomb substrate or the like is dried and baked, thus producing catalysts.

In the present invention, with respect to the ratio of the mass of catalyst (II) to the mass of catalyst (I), there is no particular limitation, but the [catalyst (I) to catalyst (II)] mass ratio is preferably 1:7 to 7:1, more preferably 1:2 to 2:1, especially preferably 1:1. By changing the amount of catalyst (I) and the amount of catalyst (II) in the above range, the hydrocarbon conversion rate and the H₂+CO formation rate can be controlled, so that the catalytic activity can be appropriately controlled according to a change of the temperature of the raw material fed or the type of the raw material fed, or a change of the calorific value generated in the hydrocarbon decomposition reaction of the raw material.

In the present invention, the average noble metal amount in the catalyst packed portion in the fuel reforming apparatus may be 0.1 to 12 g, more preferably 2.4 to 4.0 g per one liter of the packed portion. When the average noble metal amount is less than 0.1 g, a satisfactory amount of hydrogen is not generated, and, when the amount exceeds 12 g, the noble metal may suffer aggregation and cannot exhibit the catalytic activity. When each catalyst is in the form of a monolith catalyst supported on the honeycomb substrate or the like as mentioned above, the average noble metal amount may fall in the above-mentioned range per one liter of the monolith catalyst.

Examples of raw material gas fed to the reforming apparatus of the present invention include hydrocarbons having 1 to 20 carbon atoms, such as methane, ethane, propane, butane, isobutane, pentane, isopentane, hexane, isohexane, octane, isooctane, nonane, isononane, decane, and isodecane, and desulfurized gasoline containing these hydrocarbons.

The concentration of the hydrocarbon fed to the reforming apparatus is preferably 1 to 10% by volume, more preferably 1 to 5% by volume. The concentration of the desulfurized gasoline fed to the reforming apparatus is preferably 1 to 10% by volume, more preferably 1 to 5% by volume. With respect to the feed rate of the raw material gas, a GHSV may be 58837 to 137287 h⁻¹ relative to the catalyst packed portion.

### Second Embodiment

The second embodiment of the present invention is directed to a polymer electrolyte fuel cell system to which the fuel reforming apparatus according to the first embodiment is applied.

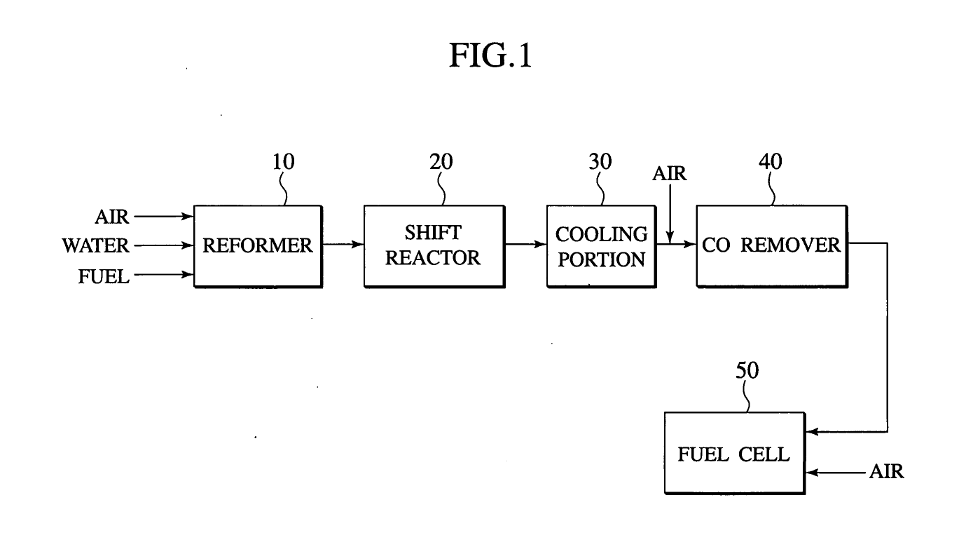

FIG. 1 shows a schematic construction of the polymer electrolyte fuel cell system. The system comprises a fuel reforming apparatus 10 according to the first embodiment, a shift reactor 20 for reducing carbon monoxide contained in the discharged gas from the fuel reforming apparatus 10 through a water-gas-shift reaction, a carbon monoxide removing apparatus 40 for removing carbon monoxide contained in the discharged gas, and a polymer electrolyte fuel cell 50. If necessary, the system may comprise a cooling portion 30, disposed between the shift reactor 20 and the carbon monoxide removing apparatus 40, for cooling the discharged gas from the shift reactor 20.

In the polymer electrolyte fuel cell system using, for example, isooctane as a fuel, as shown in FIG. 1, isooctane is reformed by the fuel reforming apparatus 10 to form reformed gas comprising hydrogen and carbon monoxide. The reformed gas is fed to the shift reactor 20 to reduce carbon monoxide contained in the reformed gas through a water-gas-shift reaction. Then, the resultant gas is fed to the carbon monoxide remover 40 comprising a catalyst layer for removing carbon monoxide contained in the gas at an outlet of the shift reactor to reduce the carbon monoxide, and thus high-purity hydrogen gas is fed to the polymer electrolyte fuel cell 50. When the discharged gas from the shift reactor 20 is preliminarily cooled by the cooling portion 30 and then fed to the carbon monoxide remover 40, excellent carbon monoxide removal efficiency can be obtained.

As a shift catalyst placed in the shift reactor 20, for example, a Pt catalyst or a Cu—ZnO catalyst can be used, and, as a catalyst placed in the CO remover 40, for example, a Pt catalyst or a Ru catalyst can be used. The polymer electrolyte fuel cell 50 comprises a solid polymer electrolytic film selectively permeable to hydrogen ions sandwiched between an anode and a cathode, and an electrochemical reaction of the fuel gas fed proceeding at the anode and cathode causes an electromotive force, thus generating electricity. Instead of the polymer electrolyte fuel cell 50, a solid oxide fuel cell can be used.

As described above, in the fuel reforming apparatus of the present invention, the catalyst packed portion contains therein fuel reforming catalyst (I) having excellent hydrocarbon conversion rate and fuel reforming catalyst (II) having excellent H₂+CO formation rate, and hence the excellent hydrocarbon decomposition performance allows the raw material gas to reach the equilibrium composition even at low temperatures, and catalyst (II) rapidly generates hydrogen gas and carbon monoxide gas. Therefore, excellent hydrogen generation rate can be obtained even at start-up. Particularly, hydrocarbon can be efficiently decomposed to generate hydrogen even when the concentration or temperature of the raw material gas fed changes, and therefore the fuel reforming apparatus can be effectively used in an vehicle whose mount range is limited. When the fuel cell system using the fuel reforming apparatus of the present invention shown in FIG. 1 is mounted on an vehicle, a fuel cell car having excellent starting-up properties can be obtained. Further, the polymer electrolyte fuel cell 50 is removed from the fuel cell system shown in FIG. 1, and the resultant system can be independently used as a hydrogen generating system in various applications requiring hydrogen.

### EXAMPLES

Hereinbelow, the present invention will be described with reference to the following Examples.

A method for preparing the reforming catalyst used in the present invention is as follows.

### Catalyst Preparation Example 1

Al₂O₃ (BET specific surface area: 200 m²/g) was used as a carrier, and the carrier was added to 0.36 liter of a 0.058 M aqueous solution of rhodium nitrate so that the carrier was impregnated with a rhodium element, and the resultant mixture was satisfactorily stirred, and then dried for one day, followed by baking at 500° C., to obtain catalyst 1.

Subsequently, 0.47 liter of water was added to catalyst 1, and the catalyst was wet-milled to prepare a slurry, and the slurry was applied to a honeycomb substrate made of ceramic (6 mils, 400 cells; hereinafter, referred to as “cerahoneycomb”) and dried at 120° C., and baked in air at 400° C. to obtain monolith catalyst 1. In the milling, a commercially available ball-type vibration mill was used, and the ball diameter, the milling time, the amplitude of vibration, and the number of vibration were adjusted so that the resultant slurry has an average particle size of 2 to 3 μm, and catalyst 1 was supported so that the catalyst amount became 120 g per one liter of the cerahoneycomb. The amount of the noble metal supported was 2.4 g per one liter of the cerahoneycomb in terms of a metal.

### Catalyst Preparation Example 2

Using platinum nitrate, ruthenium nitrate, and palladium nitrate, Pt, Ru, and Pd were individually supported on Al₂O₃ in the same manner as in Catalyst Preparation Example 1 to prepare catalyst 2, catalyst 3, and catalyst 4.

Subsequently, monolith catalysts 2 to 4 were individually obtained in substantially the same manner as in Catalyst Preparation Example 1 except that, instead of catalyst 1, catalysts 2 to 4 were individually used. The amount of the noble metal supported was 2.4 g per one liter of the cerahoneycomb in terms of a metal.

### Catalyst Preparation Example 3

Substantially the same procedure as in Catalyst Preparation Example 1 was conducted except that the concentration of the aqueous solution of rhodium nitrate was changed to 0.29 M or 0.0029 M to obtain catalysts 5 and 6.

Monolith catalysts 5 and 6 were individually obtained in substantially the same manner as in Catalyst Preparation Example 1 except that, instead of catalyst 1, catalysts 5 and 6 were individually used. The respective amounts of the noble metal supported were 0.12 g and 12 g per one liter of the cerahoneycomb in terms of a metal.

### Catalyst Preparation Example 4

Substantially the same procedure as in Catalyst Preparation Example 1 was conducted except that, instead of the Al₂O₃, ZrO₂ (BET specific surface area: 100 m²/g), TiO₂ (BET specific surface area: 40 m²/g), and CeO₂ (BET specific surface area: 127 m²/g) were individually used as a carrier to obtain catalysts 7 to 9.

Subsequently, monolith catalysts 7 to 9 were individually obtained in substantially the same manner as in Catalyst Preparation Example 1 except that, instead of catalyst 1, catalysts 7 to 9 were individually used. The amount of the noble metal supported was respectively 2.4 g per one liter of the cerahoneycomb in terms of a metal.

### Catalyst Preparation Example 5

Substantially the same procedure as in Catalyst Preparation Example 1 was conducted except that, instead of the Al₂O₃, cerium-zirconium composite oxide (BET specific surface area: 65 m²/g) was used as a carrier to obtain catalyst 10.

Monolith catalyst 10 was obtained in the same manner as in Catalyst Preparation Example 1 except that, instead of catalyst 1, catalyst 10 was used. The amount of the noble metal supported was 4.0 g per one liter of the cerahoneycomb in terms of a metal.

### Catalyst Preparation Example 6

Using catalyst 1 obtained in Catalyst Preparation Example 1, substantially the same procedure as in Catalyst Preparation Example 1 was conducted except that, instead of the cerahoneycomb, a cerafoam (ceramic; 9 to 30 pores/inch; diameter: 75 mmΦ) was used to obtain monolith catalyst 11. The amount of the noble metal supported was 2.4 g per one liter of the cerafoam in terms of a metal.

### Catalyst Preparation Example 7

Using catalyst 1 obtained in Catalyst Preparation Example 1, the same procedure as in Catalyst Preparation Example 1 was conducted except that, instead of the cerahoneycomb, a metal foam (Ni—Cr, 20 to 50 pores/inch, diameter: 100 mmΦ) was used to obtain monolith catalyst 12. The amount of the noble metal supported was 2.4 g per one liter of the metal foam in terms of a metal.

### Catalyst Preparation Example 8

Pt, Ru, and Pd were individually supported in substantially the same manner as in Catalyst Preparation Example 1 except that, instead of the Al₂O₃, CeO₂ (BET specific surface area: 127 m²/g) was used as a carrier, and platinum nitrate, ruthenium nitrate, and palladium nitrate were individually used to prepare catalysts 13 to 15. The amount of the noble metal supported was respectively 2.4 g per one liter of the cerahoneycomb in terms of a metal.

### Catalyst Preparation Example 9

Using catalyst 9 (carrier: cerium oxide, noble metal: rhodium element) obtained in Catalyst Preparation Example 4, substantially the same procedure as in Catalyst Preparation Example 4 was conducted except that, instead of the cerahoneycomb, a cerafoam was used to obtain monolith catalyst 16. The amount of the noble metal supported was 2.4 g per one liter of the cerafoam in terms of a metal.

### Catalyst Preparation Example 10

Using catalyst 9 (carrier: cerium oxide, noble metal: rhodium element) obtained in Catalyst Preparation Example 4, substantially the same procedure as in Catalyst Preparation Example 4 was conducted except that, instead of the cerahoneycomb, a metal foam was used to obtain monolith catalyst 17. The amount of the noble metal supported was 2.4 g per one liter of the metal foam in terms of a metal.

### Reaction Example 1

10 ml of monolith catalyst 1 obtained in the above Catalyst Preparation Example was placed in a quartz tube to form a catalyst packed portion.

Separately, 5 ml of monolith catalysts 2 to 4 obtained in the above Catalyst Preparation Examples were placed in a front section of respective quartz tubes, and 5 ml of monolith catalysts 13 to 15 were respectively placed in a back section to form catalyst packed portions. In Table 1, the indication “Front to back ratio” designates a “catalyst in the front section/catalyst in the back section” mass ratio is shown.

Mixed gas of isooctane, steam, and air was fed to each catalyst packed portion at a space velocity of 58,837 h⁻¹, S/C=1.5, and O₂/C=0.4. With respect to the reaction temperature, the inlet temperature was changed from 350 to 750° C., and the outlet gas was analyzed to observe the H₂+CO formation rate and the isooctane conversion rate. The isooctane conversion rate was determined by making calculation in accordance with the following Formula 3:

$$Isooctane conversion rate ( \% ) = \frac{\begin{matrix}( Isooctane concentration at inlet ) - \\ ( Isooctane concentration at outlet )\end{matrix}}{( Isooctane concentration at inlet )} \times 100 \qquad ( Formula 3 )$$

Further, the CO formation rate was determined by making calculation based on a calibration curve obtained using specified CO compressed gas, and the H₂ formation rate was determined by making calculation based on a calibration curve obtained using specified H₂ compressed gas. The catalyst composition, and the isooctane conversion rate and (hydrogen gas+CO) formation rate at outlet temperatures of 587° C., 650° C., and 700° C. are shown in Table 1 at Reaction Example 1. In Table 1, the indication “Noble metal amount” designates a catalyst amount per one liter of the catalyst packed portion (in terms of a metal) with respect to the total amount of the noble metal in the catalyst contained in the front section of the catalyst packed portion and that in the catalyst contained in the back section. Further, in the Table, the “cerium-zirconium composite oxide” is indicated by “MCZ”.

From the results, it has been found that the catalyst having Rh supported has high isooctane conversion rate and high H₂+CO formation rate in both the low temperature region and the high temperature region, as compared to the catalyst having another noble metal supported. Therefore, Rh is considered a noble metal more effective in the reforming reaction than other metals.

### Reaction Example 2

Catalyst packed portions having the constructions shown in Table 1 were individually prepared in substantially the same manner as in Reaction Example 1 except that, instead of monolith catalysts 2 to 4, monolith catalysts 5 and 6 were individually used in the front section of the quartz tube and, instead of monolith catalysts 13 to 15, monolith catalyst 9 was used in the back section, determining an isooctane conversion rate and an H₂+CO formation rate. The conversion rate and H₂+CO formation rate at outlet temperatures of 587° C., 650° C., and 700° C. are shown in Table 1 at Reaction Example 2.

As seen from the results of Reaction Examples 1 and 2, when the Rh/Al₂O₃ catalyst having a noble metal amount of 2% by mass is contained in the front section, both the isooctane conversion rate and the H₂+CO formation rate are high in each of the low temperature region and the high temperature region, as compared to those obtained when the Rh/Al₂O₃ catalyst having a noble metal amount of 0.1% by mass or 10% by mass is contained in the front section. The reason for this is presumed that, when the noble metal amount is too small, the noble metal amount is unsatisfactory for advancing the reforming reaction, and, conversely, when the noble metal amount is too large, the dispersibility of the noble metal is lowered, reducing active sites of Rh. Therefore, it is especially preferred that the amount of the noble metal supported on the catalyst is 2% by mass.

### Reaction Example 3

Catalyst packed portions having the constructions shown in Table 1 were individually prepared in substantially the same manner as in Reaction Example 1 except that, instead of monolith catalyst 1, monolith catalysts 7 to 10 were individually used, determining an isooctane conversion rate and an H₂+CO formation rate. The conversion rate and H₂+CO formation rate at outlet temperatures of 587° C., 650° C., and 700° C. are shown in Table 1 at Reaction Example 3.

Comparison was made between the results of the isooctane reforming reaction tests in Reaction Examples 1 and 3 using the catalysts comprising 2% by mass of Rh and Al₂O₃, ZrO₂, TiO₂, CeO₂, or cerium-zirconium composite oxide having the Rh supported thereon. The conversion rate in the low temperature region of Rh/Al₂O₃, Rh/TiO₂, and Rh/ZrO₂ is higher than that of Rh/CeO₂ and Rh/cerium-zirconium composite oxide. On the other hand, the H₂+CO formation rate in the low temperature region of Rh/CeO₂ and Rh/cerium-zirconium composite oxide is higher than that of Rh/Al₂O₃, Rh/TiO₂, and Rh/ZrO₂. Therefore, it is considered that Rh/Al₂O₃, Rh/TiO₂, and Rh/ZrO₂ are advantageously in decomposition of isooctane, but they are poor in steam reforming ability for the isooctane decomposed into CH_{X}, as compared to Rh/CeO₂ and Rh/cerium-zirconium composite oxide, and hence they have only a small H₂+CO formation rate.

### Reaction Example 4

Catalyst packed portions having the compositions shown in Table 1 were individually prepared in substantially the same manner as in Reaction Example 2 except that, instead of monolith catalysts 2 and 3, monolith catalysts 1, 7, and 8 were individually used as a catalyst in the front section and, instead of monolith catalysts 13 to 15, monolith catalysts 9 and 10 were individually used as a catalyst in the back section, determining an isooctane conversion rate and an H₂+CO formation rate. The conversion rate and H₂+CO formation rate at outlet temperatures of 587° C., 650° C., and 700° C. are shown in Table 1 at Reaction Example 4.

From the results, the catalyst in which Rh/Al₂O₃ is contained in the front section and Rh/CeO₂ is contained in the back section wherein the front to back ratio is 1:1 (hereinafter, referred to as “Rh/Al₂O₃+Rh/CeO₂”) has the highest H₂+CO formation rate in the low temperature region, as compared to the one using the same catalyst in both the front section and the back section. Further, it has been found that the Rh/Al₂O₃+Rh/CeO₂ has the highest conversion rate. From this, by using Rh/Al₂O₃ in the front section to increase the conversion rate and using a catalyst having high H₂+CO formation rate, such as Rh/CeO₂, in the back section, a catalyst having very excellent H₂+CO formation in the low temperature is achieved.

### Reaction Example 5

Catalyst packed portions having the constructions shown in Table 1 were individually prepared in substantially the same manner as in Example 2 except that monolith catalysts 11 and 12 were individually used as a catalyst in the front section and monolith catalysts 16 and 17 were individually used as a catalyst in the back section, determining an isooctane conversion rate and an H₂+CO formation rate. The conversion rate and H₂+CO formation rate at outlet temperatures of 587° C., 650° C., and 700° C. are shown in Table 1 at Reaction Example 5.

From the results, it has been found that the H₂+CO formation rate of the catalyst using a metal foam or a cerafoam as a carrier and that of the catalyst using a cerahoneycomb as a carrier are almost the same. From this, there is no difference in the H₂+CO formation rate between the metal foam, the cerafoam, and the cerahoneycomb, and, from the viewpoint of preventing clogging, the cerahoneycomb is more desired.

### Reaction Example 6

Catalyst packed portions having the constructions shown in Table 1 were individually prepared in substantially the same manner as in Reaction Example 2 except that monolith catalyst 1 was used as a catalyst in the front section and monolith catalyst 9 was used as a catalyst in the back section, determining an isooctane conversion rate and an H₂+CO formation rate. The conversion rate and H₂+CO formation rate at outlet temperatures of 587° C., 650° C., and 700° C. are shown in Table 1 at Reaction Example 6.

From the results, it is considered that, when the noble metal amount is too small, the reforming reaction activity is lowered, and, conversely, when the noble metal amount is too large, sintering is caused during the reaction, lowering the reforming reaction activity. From this, it is considered that the noble metal amount is more preferably 1.2 to 2.4 g/L.

### Reaction Example 7

Catalyst packed portions having the constructions shown in Table 1 were individually prepared in substantially the same manner as in Reaction Example 2 except that monolith catalyst 1 was used as a catalyst in the front section and monolith catalyst 9 was used as a catalyst in the back section, determining an isooctane conversion rate and an H₂+CO formation rate. The conversion rate and H₂+CO formation rate at outlet temperatures of 587° C., 650° C., and 700° C. are shown in Table 1 at Reaction Example 7.

From the results, it has been found that the conversion rate and H₂+CO formation rate obtained when the amount of the catalyst used in the front section is 1 part by mass and the amount of the catalyst used in the back section is 7 parts by mass are similar to those obtained when using solely the catalyst used in the back section. Further, similarly, the conversion rate and H₂+CO formation rate obtained when the amount of the front section catalyst is 7 parts by mass and the amount of the back section catalyst (II) is 1 part by mass are similar to those obtained when using solely the catalyst used in the front section. When the mass of the catalyst in the front section and the mass of the catalyst in the back section are largely different, the effect aimed at by using catalysts comprising two sections is not obtained. From this, it is most preferred that the front section to back section mass ratio for the catalysts is 1:1.

### Catalyst Preparation Example 11

Al₂O₃ (BET specific surface area: 200 m²/g), ZrO₂ (BET specific surface area: 100 m²/g), TiO₂ (BET specific surface area: 40 m²/g), CeO₂ (BET specific surface area: 127 m²/g), and cerium-zirconium composite oxide (hereinafter, referred to also as “MCZ”) (BET specific surface area: 65 m²/g) were used as a carrier, and each carrier was added to 0.36 liter of a 0.058 M aqueous solution of rhodium nitrate so that the carrier was impregnated with a rhodium element, and the resultant mixture was satisfactorily stirred, and then dried for one day, followed by baking at 500° C., to obtain rhodium-supported catalysts (a rhodium-supported Al₂O₃ catalyst, a rhodium-supported ZrO₂ catalyst, a rhodium-supported TiO₂ catalyst, a rhodium-supported CeO₂ catalyst, and a rhodium-supported MCZ catalyst).

### Catalyst Preparation Example 12

Pt, Ru, and Pd were individually supported on Al₂O₃ in substantially the same manner as in Catalyst Preparation Example 11 except that, instead of rhodium nitrate, platinum nitrate, ruthenium nitrate, and palladium nitrate were individually used.

### Catalyst Preparation Example 13

0.5 Liter of water was added to 200 g of each of the catalysts obtained in Catalyst Preparation Example 11 or Catalyst Preparation Example 12, and each catalyst was wet-milled to prepare a slurry. In the milling, a commercially available ball-type vibration mill was used, and the ball diameter, the milling time, the amplitude of vibration, and the number of vibration were adjusted so that the resultant slurry has an average particle size of 2 to 3 μm.

### Catalyst Preparation Example 14

Each slurry of a catalyst comprising Al₂O₃ having rhodium supported thereon (rhodium-supported Al₂O₃ catalyst) obtained in Catalyst Preparation Example 13 was applied to a cerahoneycomb so that the catalyst amount became 130 to 200 g/L per one liter of the cerahoneycomb, and dried at 120° C., and baked in air at 400° C. to obtain a monolith catalyst.

### Catalyst Preparation Example 15

In accordance with the description of Reaction Example 8 shown in Table 2, another catalyst slurry was further applied to the monolith catalyst used in Catalyst Preparation Example 14 and dried at 120° C., and baked in air at 400° C. to obtain a monolith catalyst having a reforming catalyst composition supported.

### Catalyst Preparation Example 16

In accordance with the descriptions of Reaction Examples and Comparative Examples shown in Table 2, instead of the cerahoneycomb, a cerafoam (ceramic; 9 to 30 pores/inch; diameter: 75 mmΦ) or a metal foam (Ni—Cr; 20 to 50 pores/inch; diameter: 100 mmΦ) was used to prepare monolith catalysts coated with a slurry of a reforming catalyst composition having the formulation shown in Table 2. The results including the amount of the noble metal supported on the catalysts are shown in Table 2.

### Reaction Example 8

Isooctane reforming reaction tests for the catalysts prepared in the above Catalyst Preparation Examples were conducted. 10 ml of the monolith catalyst was placed in a quartz tube, and mixed gas of isooctane, steam, and air was fed to the tube so that the space velocity SV became 15, 25, and 35. In this instance, S/C=1.5, and O₂/C=0.4. With respect to the reaction temperature, the inlet temperature was changed from 350 to 750° C., and the H₂+CO formation rate (%) and isooctane conversion rate (%) for the fuel cell raw material components at an outlet temperature of 587° C. were observed. When SV=15, the amount of the catalyst used was 10 ml, and, when SV=25 and 35, the amount of the catalyst used was 5 ml. The isooctane conversion rate was determined by making calculation in accordance with formula 1 above.

Further, the CO formation rate was determined by making calculation based on a calibration curve obtained using specified CO compressed gas, and the H₂ formation rate was determined by making calculation based on a calibration curve obtained using specified H₂ compressed gas. The catalyst composition, and the isooctane conversion rate and the (hydrogen gas+CH₄) formation rate are shown in Table 2 at an item of Reaction Example 8. In Table 2, the indication “Noble metal amount” designates a catalyst amount per one liter of the catalyst packed portion (in terms of a metal) with respect to the total amount of the noble metal in catalyst (I) and that in catalyst (II) contained in the catalyst packed portion.

From the results, it has been found that the catalyst having Rh supported has high isooctane conversion rate and high H₂+CO formation rate, as compared to the catalyst having another metal supported. The reason for this is that Rh is a noble metal more effective in the ATR reaction than other metals.

### Reaction Example 9

The results of the tests in which the amount of the rhodium supported was changed to 0.1 or 10% by mass are shown in Table 2.

Considering the data of Reaction Example 11, when using the Rh/Al₂O₃ catalyst having a rhodium supported amount of 2% by mass, both the isooctane conversion rate and the H₂+CO formation rate were high, as compared to those obtained when using the Rh/Al₂O₃ catalyst having a rhodium supported amount of 0.1% by mass or 10% by mass. The reason for this includes the same reason as that for Reaction Example 2. Therefore, it is especially preferred that the amount of the noble metal supported on the catalyst is 2% by mass.

### Reaction Example 10

Isooctane reforming reaction tests were conducted in substantially the same manner as in Reaction Example 8 except that the catalysts used individually comprise 2% by mass of Rh and Al₂O₃, ZrO₂, TiO₂, CeO₂, or MCZ having the Rh supported thereon. The results of the tests are shown in Table 2.

### Reaction Example 11

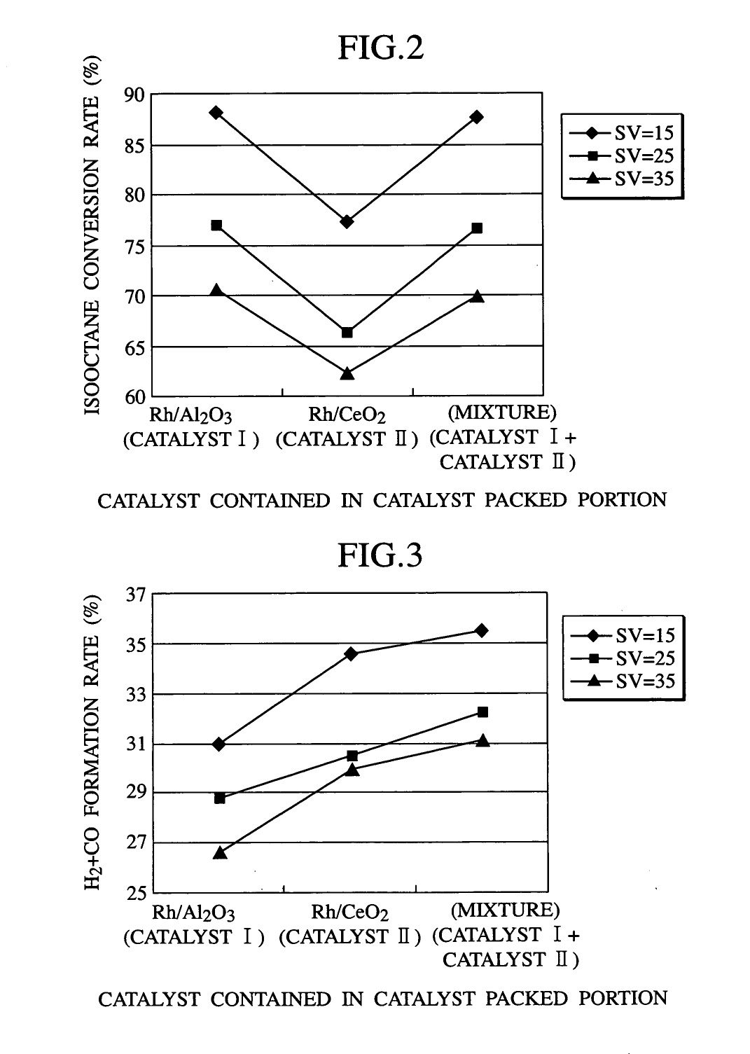

Isooctane reforming reaction tests were conducted in substantially the same manner as in Reaction Example 8 except that the carrier in the catalyst was changed. The results of the tests are shown in Table 2 and FIGS. 2 and 3. FIGS. 2 and 3 are graphs showing the isooctane conversion rate (%) and H₂+CO formation rate (%) obtained when using a catalyst composition of Rh/Al₂O₃ and Rh/CeO₂ in a 1:1 ratio prepared by coating a slurry of the catalyst composition onto a honeycomb. As seen from FIG. 2, in each case of SV=15, 25, and 35, the conversion rate of the catalyst composition was substantially equivalent to the conversion rate of Rh/Al₂O₃. However, as shown in FIG. 3, in each case of SV=15, 25, and 35, the H₂+CO formation rate obtained when using the catalyst composition was higher than those obtained when using solely Rh/Al₂O₃ or Rh/CeO₂. The catalyst composition is obtained by merely mixing together a catalyst having high hydrocarbon decomposition performance, such as Rh/Al₂O₃, and a catalyst having high steam reforming performance, such as Rh/CeO₂, but it is considered that catalyst (I) having excellent hydrocarbon decomposing ability is arranged adjacent to catalyst (II) having excellent steam reforming ability, and hence heat of reaction generated in the partial oxidation reaction and heat of reaction generated from the catalyst having excellent hydrocarbon decomposition performance are transferred to the catalyst having excellent steam reforming ability before being released, thus enabling effective utilization of the heat. That is, it is considered that heat of reaction generated in the partial oxidation reaction and the isooctane decomposition reaction proceeding on the Rh/Al₂O₃ can be utilized before being released, and further the catalyst for promoting the hydrocarbon decomposition reaction and the layer for promoting the steam reforming reaction are formed from, for example, Rh/Al₂O₃ and Rh/CeO₂, and therefore the hydrocarbon is satisfactorily decomposed into CH_{X} and then passes through the layer of the catalyst having excellent steam reforming performance, so that the highest H₂+CO formation rate is exhibited at high SV.

### Reaction Example 12

Isooctane reforming reaction tests were conducted in substantially the same manner as in Reaction Example 8 except that, instead of the cerahoneycomb, a metal foam or a cerafoam was used in the catalyst. The results are shown in Table 2.

From the results, it has been found that the H₂+CO formation rate of the catalyst using a metal foam or a cerafoam as a carrier and that of the catalyst using a cerahoneycomb as a carrier are almost the same. From this, there is no difference in the H₂+CO formation rate between the metal foam, the cerafoam, and the cerahoneycomb, and, from the viewpoint of preventing clogging, the cerahoneycomb is advantageous.

### Reaction Example 13

Isooctane reforming reaction tests were conducted in substantially the same manner as in Reaction Example 8 except that the amount of the noble metal supported on the catalyst was changed to 0.1 or 12 g/L. The results are shown in Table 2. The amount of the noble metal supported corresponds to the total amount of the noble metal in catalyst (I) and that in catalyst (II).

For the same reason as that for Reaction Example 6, it is more desired that the noble metal amount is 1.2 to 2.4 g/L.

### Reaction Example 14

Isooctane reforming reaction tests were conducted in substantially the same manner as in Reaction Example 8 except that the mixing ratio between catalyst (I) having excellent hydrocarbon decomposition performance and catalyst (II) having excellent steam reforming performance was changed to 1:7 and 7:1. The results are shown in Table 2.

From the results, the conversion rate and H₂+CO formation rate obtained when using the catalyst having excellent hydrocarbon decomposition performance and the catalyst having excellent steam reforming performance in a 1:7 mixing ratio are similar to those obtained when using solely the catalyst which is the one used in a seven-time amount in the above catalyst composition. It has been found that, when the amount of any one of the catalysts in the catalyst composition is too small, almost no effect of the catalyst composition is obtained, and the result of such a case is not different from the result of the case using solely the catalyst used in a larger amount in the catalyst composition. From this, it is more desired that the catalyst (I) to catalyst (II) ratio is 1:1.

### Catalyst Preparation Example 17

In accordance with the description of Reaction Example 15 shown in Table 3, another catalyst slurry was further applied to the monolith catalyst prepared in Catalyst Preparation Example 14 so that the amount of the noble metal supported became 2.4 g in terms of a metal, and dried at 120° C., and baked in air at 400° C. to obtain a two-layer coat monolith catalyst.

### Catalyst Preparation Example 18

In accordance with the descriptions of Reaction Examples shown in Table 3, instead of the honeycomb substrate made of ceramic (6 mils, 400 cells; hereinafter, referred to as “cerahoneycomb”), a cerafoam (ceramic; 9 to 30 pores/inch; diameter: 75 mmΦ) or a metal foam (Ni—Cr; 20 to 50 pores/inch; diameter: 100 mmΦ) was used to prepare two-layer coat catalysts each comprising a surface layer catalyst and an inner layer catalyst shown in Table 3. The results including the amount of the noble metal supported on the catalysts are shown in Table 3.

### Reaction Example 15

Isooctane reforming reaction tests for the catalysts prepared in Catalyst Preparation Example 18 were conducted in substantially the same manner as in Reaction Example 8 except that 10 ml of a two-layer coat catalyst was placed in a quartz tube. The catalyst composition, and the isooctane conversion rate and the (hydrogen gas+CH₄) formation rate are shown in Table 3 at an item of Reaction Example 15. In Table 3, the indication “Noble metal amount” designates a catalyst amount per one liter of the catalyst packed portion (in terms of a metal) with respect to the total amount of the noble metal in the inner layer catalyst and that in the surface layer catalyst contained in the catalyst packed portion.

From the results, it has been found that the catalyst having Rh supported has high isooctane conversion rate and high H₂+CO formation rate, as compared to the catalyst having another metal supported. The reason for this is that Rh is a noble metal more effective in the ATR reaction than other metals. Further, it has been found that any catalysts are reduced in both the isooctane conversion rate and the H₂+CO formation rate as the SV is increased, i.e., 15, 25, and 35. The reason for this is presumed that, when the SV is increased, a time during which isooctane is in contact with the catalyst layer is shortened.

### Reaction Example 16

The results of the tests in which the amount of the noble metal supported was changed to 0.1 or 10% by mass are shown in Table 3.

Comparing with the data of Reaction Example 18, when using the Rh/Al₂O₃ catalyst having a noble metal supported amount of 2% by mass, both the isooctane conversion rate and the H₂+CO formation rate were high, as compared to those obtained when using the Rh/Al₂O₃ catalyst having a noble metal supported amount of 0.1% by mass or 10% by mass. The reason for this includes the same reason as that for Reaction Example 2. Therefore, it is especially preferred that the amount of the noble metal supported on the catalyst is 2% by mass.

### Reaction Example 17

Isooctane reforming reaction tests were conducted in the same manner as in Reaction Example 15 except that the catalysts used individually comprise 2% by mass of Rh and Al₂O₃, ZrO₂, TiO₂, CeO₂, or MCZ having the Rh supported thereon. The results of the tests are shown in Table 3.

### Reaction Example 18

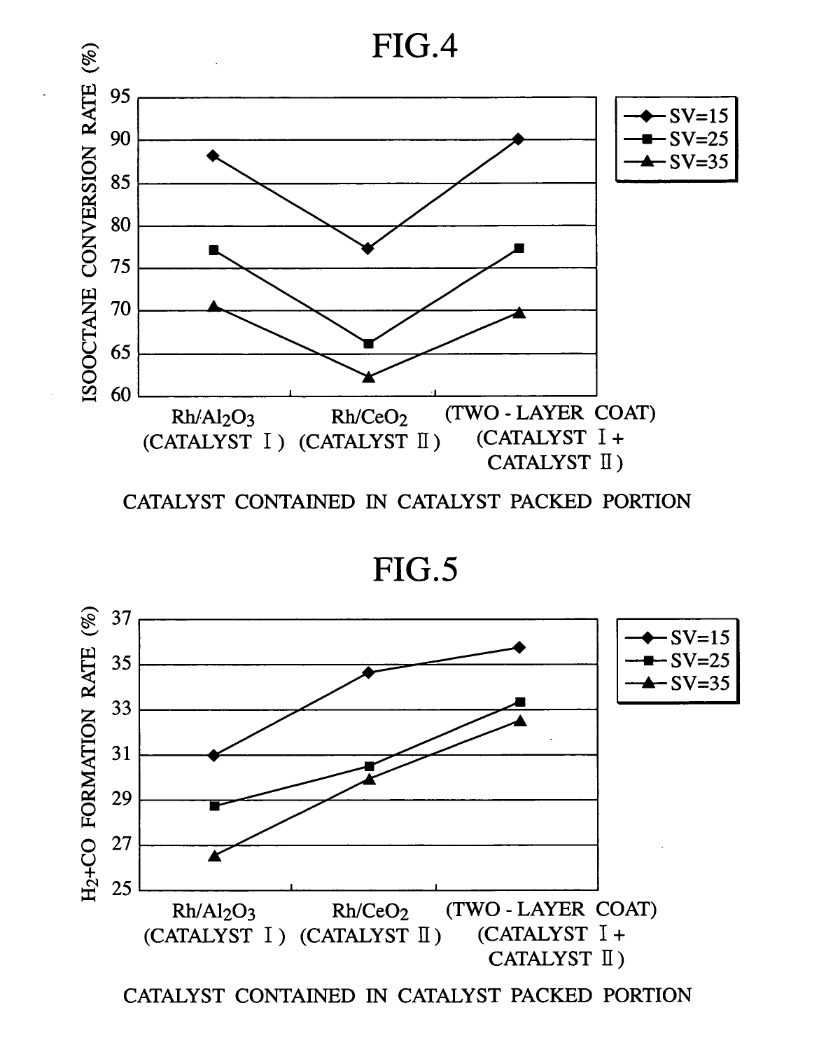

Isooctane reforming reaction tests were conducted in substantially the same manner as in Reaction Example 15 except that the carrier in the catalyst was changed. The results of the tests are shown in Table 3 and FIGS. 4 and 5. FIGS. 4 and 5 are graphs showing the isooctane conversion rate (%) and H₂+CO formation rate (%) of a two-layer coat catalyst comprising Rh/Al₂O₃ as a surface layer and Rh/CeO₂ as an inner layer wherein the surface layer to inner layer ratio is 1:1. As seen from FIG. 4, in each case of SV=15, 25, and 35, the conversion rate of the two-layer coat catalyst was substantially equivalent to the conversion rate of Rh/Al₂O₃. However, as shown in FIG. 5, in each case of SV=15, 25, and 35, the H₂+CO formation rate of the two-layer coat catalyst was higher than that of Rh/Al₂O₃ or Rh/CeO₂ solely. It is considered that the two-layer coat catalyst comprises a surface layer comprising a catalyst having high hydrocarbon decomposition performance, for example, Rh/Al₂O₃ and an inner layer comprising a catalyst having high steam reforming performance, for example, Rh/CeO₂, and hence heat of reaction generated in the partial oxidation reaction and the isooctane decomposition reaction proceeding on the Rh/Al₂O₃ can be utilized before being released, and further the catalyst for promoting the hydrocarbon decomposition reaction and the layer for promoting the steam reforming reaction are formed from, for example, Rh/Al₂O₃ and Rh/CeO₂, and therefore the hydrocarbon is satisfactorily decomposed into CH_{X} and then passes through the layer of the catalyst having excellent steam reforming performance, so that the highest H₂+CO formation rate is exhibited at high SV.

### Reaction Example 19

Isooctane reforming reaction tests were conducted in substantially the same manner as in Reaction Example 15 except that, instead of the cerahoneycomb, a metal foam or a cerafoam was used in the catalyst. The results are shown in Table 2. From the results, there is no difference in the H₂+CO formation rate between the metal foam, the cerafoam, and the cerahoneycomb, and, from the viewpoint of preventing clogging, the cerahoneycomb is advantageous.

### Reaction Example 20

Isooctane reforming reaction tests were conducted in substantially the same manner as in Reaction Example 15 except that the amount of the noble metal supported on the catalyst was changed to 0.1 or 12 g/L. The results are shown in Table 3.

For the same reason as that for Reaction Example 6, it is more desired that the noble metal amount is 1.2 to 2.4 g/L.

### Reaction Example 21

Isooctane reforming reaction tests were conducted in substantially the same manner as in Reaction Example 15 except that the ratio of surface layer and inner layer between catalyst (I) having excellent hydrocarbon decomposition performance and catalyst (II) having excellent steam reforming performance was changed to 1:7 and 7:1. The results are shown in Table 3.

From the results, the conversion rate and H₂+CO formation rate obtained when using the catalyst having excellent hydrocarbon decomposition performance and the catalyst having excellent steam reforming performance in a surface layer to inner layer ratio of 1:7 are similar to those obtained when using solely the catalyst which is the one used in a seven-time amount in the above two-layer coat catalyst. It has been found that, when the amount of the inner layer or surface layer is too small, almost no effect of the two-layer coat catalyst is obtained, and the result of such a case is not different from the result of the case using solely the catalyst used in a larger amount in the two-layer coat catalyst. From this, it is more desired that the surface layer to inner layer ratio for the catalyst is 1:1.

### Reaction Example 22

1.34 ml of monolith catalysts 1 and 9 obtained in Catalyst Preparation Examples 1 and 4 were individually placed in quartz tubes to form catalyst packed portions. Mixed gas of desulfurized gasoline, steam, and air was fed to each catalyst packed portion at space velocity: GHSV=111308 h⁻¹, LHSV=25, S/C=1.5, and O₂/C=0.4. With respect to the reaction temperature, the inlet temperature was changed from 400 to 700° C., and the outlet gas was analyzed to observe the H₂+CO formation rate and the desulfurized gasoline conversion rate. The desulfurized gasoline conversion rate was determined by making calculation in accordance with the following Formula 4:

$$Desulfurized gasoline conversion rate ( \% ) = \frac{\begin{matrix}( carbon content at inlet ) - \\ ( carbon content at outlet )\end{matrix}}{( carbon content at inlet )} \times 100 \qquad ( Formula 4 )$$

The conversion rate and H₂+CO formation rate at inlet temperatures of 400° C., 500° C., and 600° C. are shown in Table 4 at Reaction Example 22. In Table 4, the indication “Noble metal amount” designates a catalyst amount per one liter of the catalyst packed portion (in terms of a metal) with respect to the total amount of the noble metal in the catalyst contained in the front section of the catalyst packed portion and that in the catalyst contained in the back section.

From the results, it has been found that, as the inlet temperature is increased, both the desulfurized gasoline conversion rate and the H₂+CO formation rate are improved. However, differing from the results of Reaction Examples 1 and 3 for Rh/Al₂O₃ and Rh/CeO₂, no remarkable difference is found in the conversion rate and H₂+CO formation rate between these catalysts. The reason for this is not elucidated, but it is presumed that desulfurized gasoline used as a fuel causes no difference between the catalysts.

### Reaction Example 23

Catalyst packed portions having the constructions shown in Table 4 were individually prepared in substantially the same manner as in Reaction Example 22 except that 0.67 ml of monolith catalyst 1 obtained in the above Catalyst Preparation Example was placed in the front section of a quartz tube, and 0.67 ml of monolith catalyst 9 was placed in the back section, and the outlet gas was analyzed to observe the H₂+CO formation rate and the desulfurized gasoline conversion rate. The conversion rate and H₂+CO formation rate at inlet temperatures of 400° C., 500° C., and 600° C. are shown in Table 4 at Reaction Example 23.

From a comparison between the catalyst in Reaction Example 22 using solely the Rh/Al₂O₃ or Rh/CeO₂ catalyst in the front section and the Rh/Al₂O₃+Rh/CeO₂ catalyst in Reaction Example 23, it has been found that especially the catalyst having a front section to back section ratio of 1:1 is remarkably improved in both the conversion rate and the H₂+CO formation rate at each inlet temperature. From this, like the results of the isooctane reforming tests in Reaction Example 7, it is most preferred that the front section to back section mass ratio for the catalysts is 1:1.

In addition, it has been found that the catalyst in which Rh/Al₂O₃ is contained in the front section and Rh/CeO₂ is contained in the back section wherein the front to back ratio is 1:1 exhibits excellent effect in the isooctane reforming test in Reaction Example 4, and further also exhibits excellent effect in the desulfurized gasoline reforming test.

### Reaction Example 24

A catalyst packed portion having the construction shown in Table 4 was prepared in substantially the same manner as in Reaction Example 9 except that monolith catalyst 1 obtained in Catalyst Preparation Example 1 was used as a catalyst in the front section and a catalyst in the back section, determining a desulfurized gasoline conversion rate and an H₂+CO formation rate.

Further, a catalyst packed portion having the construction shown in Table 4 was prepared in substantially the same manner as in Reaction Example 9 except that monolith catalyst 9 obtained in Catalyst Preparation Example 4 was used as a catalyst in the front section and monolith catalyst 1 was used as a catalyst in the back section, determining a desulfurized gasoline conversion rate and an H₂+CO formation rate. The conversion rate and H₂+CO formation rate at inlet temperatures of 400° C., 500° C., and 600° C. are shown in Table 4 at Reaction Example 24.

From the results, it has been found that the conversion rate and H₂+CO formation rate of the Rh/Al₂O₃+Rh/Al₂O₃ catalyst and those of the Rh/Al₂O₃ catalyst in Reaction Example 22 are almost the same.

Further, it has been found that the conversion rate and H₂+CO formation rate of the catalyst in which, in contrast to the catalyst in Reaction Example 23, a catalyst comprising Rh supported on CeO₂ is contained in the front section and a catalyst comprising Rh supported on Al₂O₃ is contained in the back section are not improved but lowered, as compared to those of the Rh/Al₂O₃ or Rh/CeO₂ catalyst in Reaction Example 22. The catalyst comprising Rh supported on Al₂O₃ is a catalyst having excellent hydrocarbon decomposition performance and the catalyst comprising Rh supported on CeO₂ is a catalyst having excellent steam reforming performance, and it is presumed that the reaction scheme in which hydrocarbon is first decomposed and then subjected to steam reforming has an adverse effect when the positions of the catalysts are reversed, lowering both the conversion rate and the H₂+CO formation rate.

### Reaction Example 25

1.34 ml of monolith catalysts 1 and 9 obtained in Catalyst Preparation Examples 1 and 4 were individually placed in the front section of quartz tubes to prepare catalyst packed portions.

Mixed gas of desulfurized gasoline, steam, and air was fed to each catalyst packed portion at an inlet temperature of 500° C. at S/C=1.5, and O₂/C=0.4. The space velocity was changed: GHSV=66767 to 155861, LHSV=15 to 35, and the outlet gas was analyzed to observe the H₂+CO formation rate and the desulfurized gasoline conversion rate.

The conversion rate and H₂+CO formation rate at LHSV=15, 25, and 35 are shown in Table 4 at Reaction Example 25.

### Reaction Example 26

Catalyst packed portions having the constructions shown in Table 4 were individually prepared in substantially the same manner as in Reaction Example 25 except that 0.67 ml of monolith catalyst 1 obtained in the above Catalyst Preparation Example was placed in the front section of a quartz tube, and 0.67 ml of monolith catalyst 9 was placed in the back section, determining a desulfurized gasoline conversion rate and an H₂+CO formation rate. The conversion rate and H₂+CO formation rate at LHSV=15, 25, and 35 are shown in Table 4 at Reaction Example 26.

From the results, it has been found that, like Reaction Example 23, especially the catalyst having a front to back ratio of 1:1 is remarkably improved in both the conversion rate and the H₂+CO formation rate at each inlet temperature. From this, like the isooctane reforming tests in Reaction Example 7, it is most preferred that the front section to back section mass ratio for the catalysts is 1:1.

Further, it has been found that the Rh/Al₂O₃+Rh/CeO₂ catalyst having a front to back ratio of 1:1 exhibits excellent effect even when the inlet temperature is changed from 400 to 600° C. in Reaction Example 23, and further exhibits excellent effect even when the LHSV is changed from 15 to 35.

### Reaction Example 27

Catalyst packed portions having the constructions shown in Table 4 were individually prepared in substantially the same manner as in Reaction Example 12 except that monolith catalysts 1 and 9 were individually used as a catalyst in the front section and monolith catalyst 1 was used as a catalyst in the back section, determining a desulfurized gasoline conversion rate and an H₂+CO formation rate. The conversion rate and H₂+CO formation rate at LHSV=15, 25, and 35 are shown in Table 4 at Reaction Example 27.

From the results, it has been found that, like Reaction Example 24, the conversion rate and H₂+CO formation rate of the Rh/Al₂O₃+Rh/Al₂O₃ catalyst and those of the Rh/Al₂O₃ catalyst in Reaction Example 25 are almost the same.

Further, it has been found that, like Reaction Example 24, the conversion rate and H₂+CO formation rate of the catalyst in which, in contrast to the catalyst in Reaction Example 26, the Rh/CeO₂ catalyst is contained in the front section and the Rh/Al₂O₃ catalyst is contained in the back section are not improved but lowered, as compared to those of the Rh/Al₂O₃+Rh/CeO₂ catalyst in Reaction Example 26. The catalyst comprising Rh supported on Al₂O₃ is a catalyst having excellent hydrocarbon decomposition performance and the catalyst comprising Rh supported on CeO₂ is a catalyst having excellent steam reforming performance, and it is presumed that the reaction scheme in which hydrocarbon is first decomposed and then subjected to steam reforming has an adverse effect when the positions of the catalysts are reversed, lowering both the conversion rate and the H₂+CO formation rate.

### Reaction Example 28

Catalysts 1 and 9 obtained in Catalyst Preparation Examples 1 and 4 were mixed in respective amounts in the mixing ratio shown in Table 5, and applied to a cerahoneycomb in the same manner as in Catalyst Preparation Example 1. 1.34 ml of the thus obtained monolith catalysts 18 to 22 were individually placed in quartz tubes to form catalyst packed portions. Mixed gas of desulfurized gasoline, steam, and air was fed to each catalyst packed portion at space velocity: GHSV=111,308 h⁻¹, LHSV=25, S/C=1.5, and O₂/C=0.4. With respect to the reaction temperature, the inlet temperature was changed from 400 to 700° C., and the outlet gas was analyzed to observe the H₂+CO formation rate and the desulfurized gasoline conversion rate. The conversion rate and H₂+CO formation rate at inlet temperatures of 400° C., 500° C., and 600° C. are shown in Table 5 at Reaction Example 28. In Table 5, the indication “Noble metal amount” designates a catalyst amount per one liter of the catalyst packed portion (in terms of a metal) with respect to the total amount of the noble metal in catalyst (I) and that in catalyst (II) contained in the catalyst packed portion.

From the results, it has been found that the catalyst having a catalyst (I) to catalyst (II) ratio of 1:1 has the most excellent performance. The reason for this is presumed that the catalyst having a 1:1 ratio has the best balance of the catalysts on the upstream side and the downstream side.

Further, the catalyst packed portion comprising catalysts in the form of a mixture is remarkably excellent in the preparation, as compared to the catalyst packed portion comprising the front section and the back section in, for example, Reaction Example 23. Specifically, the catalyst packed portion comprising the front section and the back section requires two operations for the preparation, but the catalyst packed portion comprising catalysts in the form of a mixture needs only one operation for the preparation, so that the operation of the preparation can be simplified.

### Reaction Example 29

1.34 ml of monolith catalysts 18 to 22 obtained in Reaction Example 28 were individually placed in quartz tubes to form catalyst packed portions. Mixed gas of desulfurized gasoline, steam, and air was fed to each catalyst packed portion at an inlet temperature of 500° C. at S/C=1.5, and O₂/C=0.4. The space velocity was changed: GHSV=66767 to 155861, LHSV=15 to 35, and the outlet gas was analyzed to observe the H₂+CO formation rate and the desulfurized gasoline conversion rate. The conversion rate and H₂+CO formation rate at LHSV=15, 25, and 35 are shown in Table 5 at Reaction Example 29.

From the results, it has been found that, like Reaction Example 28, the catalyst having a catalyst (I) to catalyst (II) ratio of 1:1 has the most excellent performance. The reason for this is presumed that the catalyst having a 1:1 ratio has the best balance of the catalysts on the upstream side and the downstream side.

### Reaction Example 30

Coating for catalysts 1 and 9 obtained in Catalyst Preparation Examples 1 and 4 was conducted in the surface layer to inner layer ratio shown in Table 6 in the order of the inner layer and the surface layer in the same manner as in the coating method described in Catalyst Preparation Example 1. 1.34 ml of the thus obtained monolith catalysts 23 to 27 were individually placed in quartz tubes to form catalyst packed portions. Mixed gas of desulfurized gasoline, steam, and air was fed to each catalyst packed portion at space velocity: GHSV=111308 h⁻¹, LHSV=25, S/C=1.5, and O₂/C=0.4. With respect to the reaction temperature, the inlet temperature was changed from 400 to 700° C., and the outlet gas was analyzed to observe the H₂+CO formation rate and the desulfurized gasoline conversion rate. The conversion rate and H₂+CO formation rate at inlet temperatures of 400° C., 500° C., and 600° C. are shown in Table 6 at Reaction Example 30. In Table 6, the indication “Noble metal amount” designates a catalyst amount per one liter of the catalyst packed portion (in terms of a metal) with respect to the total amount of the noble metal in the inner layer catalyst and that in the surface layer catalyst contained in the catalyst packed portion.

When the two-layer coat catalyst is used, two types of catalysts are applied to the same carrier, and therefore only one operation is needed in the baking, so that the operation of the baking can be simplified, and thus the two-layer coat catalyst is excellent in the preparation.

### Reaction Example 31

Coating for catalysts 1 and 9 obtained in Catalyst Preparation Examples 1 and 4 was conducted in the surface layer to inner layer ratio shown in Table 6 in the order of the inner layer and the surface layer in the same manner as in the coating method described in Catalyst Preparation Example 1. 1.34 ml of the thus obtained monolith catalysts 23 to 27 were individually placed in quartz tubes to form catalyst packed portions. Mixed gas of desulfurized gasoline, steam, and air was fed to each catalyst packed portion at an inlet temperature of 500° C. at S/C=1.5, and O₂/C=0.4. The space velocity was changed: GHSV=66767 to 155861, LHSV=15 to 35, and the outlet gas was analyzed to observe the H₂+CO formation rate and the desulfurized gasoline conversion rate.

The conversion rate and H₂+CO formation rate at LHSV=15, 25, and 35 are shown in Table 6 at Reaction Example 31.

The disclosures of Japanese Patent Application Nos. P2002-308364 (Filing date: Oct. 23, 2002), P2002-351013 (Filing date: Dec. 3, 2002), and P2002-351014 (Filing date: Dec. 3, 2002) are incorporated by reference herein in their entirety.

While the present invention has been explained with reference to the embodiments and examples, the invention is not limited thereto. It is clear to persons skilled in the art that various changes and modifications can be appropriately made to the invention.

### INDUSTRIAL APPLICABILITY

As mentioned above, the fuel reforming apparatus of the present invention can be applied to not only a hydrogen gas source for use in polymer electrolyte fuel cell or solid oxide fuel cell but also a hydrogen generation source for use in applications other than the fuel cell. Further, the fuel cell system having the fuel reforming apparatus can be advantageously used as a fuel cell for vehicle which requires excellent starting-up properties, and can also be used as a stationary small-size electricity generator.

TABLE 1

| | | | | | | | | | | | Low temperature region | |
|---|---|---|---|---|---|---|---|---|---|---|---|---|
| | | | | | | | | | Front | | Outlet temperature | |
| | | | | | | | | | to | Amount of | (587° C.) | |
| Reaction | Front section | | | | Back section | | | | back | noble metal | Conversion | H₂ + CO |
| Example | PM | wt % | Carrier | Substrate | PM | wt % | Carrier | Substrate | ratio | (g) | rate % | % |
| 1 | Rh | 2 | Al₂O₃ | Cerahoneycomb | | | | | 1:0 | 2.4 | 88.1 | 31 |
| | Pt | 2 | Al₂O₃ | Cerahoneycomb | Pt | 2 | CeO₂ | Cerahoneycomb | 1:1 | 2.4 | 64.9 | 23.1 |
| | Ru | 2 | Al₂O₃ | Cerahoneycomb | Ru | 2 | CeO₂ | Cerahoneycomb | 1:1 | 2.4 | 75.5 | 27.7 |
| | Pd | 2 | Al₂O₃ | Cerahoneycomb | Pd | 2 | CeO₂ | Cerahoneycomb | 1:1 | 2.4 | 66.8 | 23.1 |
| 2 | Rh | 0.1 | Al₂O₃ | Cerahoneycomb | Rh | 2 | CeO₂ | Cerahoneycomb | 1:1 | 1.32 | 66.3 | 22.1 |
| | Rh | 10 | Al₂O₃ | Cerahoneycomb | Rh | 2 | CeO₂ | Cerahoneycomb | 1:1 | 13.2 | 59.4 | 22.3 |
| 3 | Rh | 2 | ZrO₂ | Cerahoneycomb | | | | | 1:0 | 2.4 | 84.8 | 28.5 |
| | Rh | 2 | TiO₂ | Cerahoneycomb | | | | | 1:0 | 2.4 | 84.8 | 29 |
| | Rh | 2 | CeO₂ | Cerahoneycomb | | | | | 1:0 | 2.4 | 77.3 | 34.6 |
| | Rh | 2 | MCZ | Cerahoneycomb | | | | | 1:0 | 4.0 | 76.8 | 33.9 |
| 4 | Rh | 2 | Al₂O₃ | Cerahoneycomb | Rh | 2 | CeO₂ | Cerahoneycomb | 1:1 | 2.4 | 89.1 | 35.2 |
| | Rh | 2 | ZrO₂ | Cerahoneycomb | Rh | 2 | CeO₂ | Cerahoneycomb | 1:1 | 2.4 | 84.7 | 35 |
| | Rh | 2 | TiO₂ | Cerahoneycomb | Rh | 2 | CeO₂ | Cerahoneycomb | 1:1 | 2.4 | 85 | 34.9 |
| | Rh | 2 | Al₂O₃ | Cerahoneycomb | Rh | 2 | MCZ | Cerahoneycomb | 1:1 | 3.2 | 88.7 | 34.2 |
| | Rh | 2 | ZrO₂ | Cerahoneycomb | Rh | 2 | MCZ | Cerahoneycomb | 1:1 | 3.2 | 84.2 | 34 |
| | Rh | 2 | TiO₂ | Cerahoneycomb | Rh | 2 | MCZ | Cerahoneycomb | 1:1 | 3.2 | 87.5 | 34.1 |
| 5 | Rh | 2 | Al₂O₃ | Cerafoam | Rh | 2 | CeO₂ | Cerafoam | 1:1 | 2.4 | 89.1 | 34.7 |
| | Rh | 2 | Al₂O₃ | Metalfoam | Rh | 2 | CeO₂ | Metalfoam | 1:1 | 2.4 | 92.2 | 35.1 |
| 6 | Rh | 2 | Al₂O₃ | Cerahoneycomb | Rh | 2 | CeO₂ | Cerahoneycomb | 1:1 | 0.1 | 8.3 | 2.2 |
| | Rh | 2 | Al₂O₃ | Cerahoneycomb | Rh | 2 | CeO₂ | Cerahoneycomb | 1:1 | 12.0 | 62.3 | 22.1 |
| 7 | Rh | 2 | Al₂O₃ | Cerahoneycomb | Rh | 2 | CeO₂ | Cerahoneycomb | 1:7 | 2.4 | 77.1 | 34.5 |
| | Rh | 2 | Al₂O₃ | Cerahoneycomb | Rh | 2 | CeO₂ | Cerahoneycomb | 7:1 | 2.4 | 87.1 | 30.8 |

| | | | | | | | | | High temperature region | | | |
|---|---|---|---|---|---|---|---|---|---|---|---|---|
| | | | | | | | | | Outlet temperature | | Outlet temperature | |
| | | | | | | | | | (650° C.) | | (700° C.) | |
| Reaction | Front section | | | | Back section | | | | Conversion | H₂ + CO | Conversion | H₂ + CO |
| Example | PM | wt % | Carrier | Substrate | PM | wt % | Carrier | Substrate | rate % | % | rate % | % |
| 1 | Rh | 2 | Al₂O₃ | Cerahoneycomb | | | | | 98.3 | 39.2 | 99.8 | 43.6 |
| | Pt | 2 | Al₂O₃ | Cerahoneycomb | Pt | 2 | CeO₂ | Cerahoneycomb | 74.9 | 28.6 | 87.7 | 35.5 |
| | Ru | 2 | Al₂O₃ | Cerahoneycomb | Ru | 2 | CeO₂ | Cerahoneycomb | 83.3 | 29.1 | 90.5 | 37.4 |
| | Pd | 2 | Al₂O₃ | Cerahoneycomb | Pd | 2 | CeO₂ | Cerahoneycomb | 77.5 | 28.8 | 88.3 | 29.1 |
| 2 | Rh | 0.1 | Al₂O₃ | Cerahoneycomb | Rh | 2 | CeO₂ | Cerahoneycomb | 70.7 | 25.8 | 88.5 | 24.4 |
| | Rh | 10 | Al₂O₃ | Cerahoneycomb | Rh | 2 | CeO₂ | Cerahoneycomb | 60.3 | 21.7 | 77.7 | 23.7 |
| 3 | Rh | 2 | ZrO₂ | Cerahoneycomb | | | | | 95.1 | 37.8 | 99.3 | 43 |
| | Rh | 2 | TiO₂ | Cerahoneycomb | | | | | 95.2 | 38.2 | 99.9 | 42.8 |
| | Rh | 2 | CeO₂ | Cerahoneycomb | | | | | 96.9 | 41.9 | 99.7 | 43.8 |
| | Rh | 2 | MCZ | Cerahoneycomb | | | | | 90.8 | 41.1 | 98.2 | 43.8 |
| 4 | Rh | 2 | Al₂O₃ | Cerahoneycomb | Rh | 2 | CeO₂ | Cerahoneycomb | 99.2 | 42.5 | 99.9 | 44.7 |
| | Rh | 2 | ZrO₂ | Cerahoneycomb | Rh | 2 | CeO₂ | Cerahoneycomb | 94.4 | 42.2 | 99.2 | 44.3 |
| | Rh | 2 | TiO₂ | Cerahoneycomb | Rh | 2 | CeO₂ | Cerahoneycomb | 98.1 | 42.2 | 99.4 | 43.7 |
| | Rh | 2 | Al₂O₃ | Cerahoneycomb | Rh | 2 | MCZ | Cerahoneycomb | 99.4 | 41.5 | 99.9 | 44.6 |
| | Rh | 2 | ZrO₂ | Cerahoneycomb | Rh | 2 | MCZ | Cerahoneycomb | 94.4 | 41.1 | 99.4 | 44.4 |
| | Rh | 2 | TiO₂ | Cerahoneycomb | Rh | 2 | MCZ | Cerahoneycomb | 97.7 | 41.1 | 99.9 | 42.8 |
| 5 | Rh | 2 | Al₂O₃ | Cerafoam | Rh | 2 | CeO₂ | Cerafoam | 99.1 | 42.3 | 99.9 | 43.8 |
| | Rh | 2 | Al₂O₃ | Metalfoam | Rh | 2 | CeO₂ | Metalfoam | 99.3 | 41.9 | 99.9 | 44.4 |
| 6 | Rh | 2 | Al₂O₃ | Cerahoneycomb | Rh | 2 | CeO₂ | Cerahoneycomb | 9.9 | 3 | 9.9 | 3.2 |
| | Rh | 2 | Al₂O₃ | Cerahoneycomb | Rh | 2 | CeO₂ | Cerahoneycomb | 65.6 | 23.1 | 70.7 | 22.2 |
| 7 | Rh | 2 | Al₂O₃ | Cerahoneycomb | Rh | 2 | CeO₂ | Cerahoneycomb | 96.6 | 41.3 | 99.8 | 43.1 |
| | Rh | 2 | Al₂O₃ | Cerahoneycomb | Rh | 2 | CeO₂ | Cerahoneycomb | 98 | 38.6 | 99.8 | 43 |

TABLE 2

| | | | | | | | | | | | Outlet temperature 587° C. | |
|---|---|---|---|---|---|---|---|---|---|---|---|---|
| | | | | | | | | | | Amount of | S V = 15 | |
| Reaction | Catalyst (I) | | | | Catalyst (II) | | | | Mixing | noble metal | Conversion | H₂ + CO |
| Example | PM | wt % | Carrier | Substrate | PM | wt % | Carrier | Substrate | ratio | (g) | rate % | % |
| 8 | Rh | 2 | Al₂O₃ | Cerahoneycomb | — | — | — | — | 1:0 | 2.4 | 88.1 | 31 |
| | Pt | 2 | Al₂O₃ | Cerahoneycomb | Pt | 2 | CeO₂ | Cerahoneycomb | 1:1 | 2.4 | 66.7 | 23.4 |
| | Ru | 2 | Al₂O₃ | Cerahoneycomb | Ru | 2 | CeO₂ | Cerahoneycomb | 1:1 | 2.4 | 73.3 | 26.5 |
| | Pd | 2 | Al₂O₃ | Cerahoneycomb | Pd | 2 | CeO₂ | Cerahoneycomb | 1:1 | 2.4 | 70.3 | 25.2 |
| 9 | Rh | 0.1 | Al₂O₃ | Cerahoneycomb | Rh | 2 | CeO₂ | Cerahoneycomb | 1:1 | 1.32 | 63.8 | 30.4 |
| | Rh | 10 | Al₂O₃ | Cerahoneycomb | Rh | 2 | CeO₂ | Cerahoneycomb | 1:1 | 13.2 | 61.2 | 28.6 |
| 10 | Rh | 2 | ZrO₂ | Cerahoneycomb | — | — | — | — | 1:0 | 2.4 | 84.8 | 28.5 |
| | Rh | 2 | TiO₂ | Cerahoneycomb | — | — | — | — | 1:0 | 2.4 | 84.8 | 29 |
| | Rh | 2 | CeO₂ | Cerahoneycomb | — | — | — | — | 1:0 | 2.4 | 77.3 | 34.6 |
| | Rh | 2 | MCZ | Cerahoneycomb | — | — | — | — | 1:0 | 4.0 | 76.8 | 33.9 |
| 11 | Rh | 2 | Al₂O₃ | Cerahoneycomb | Rh | 2 | CeO₂ | Cerahoneycomb | 1:1 | 2.4 | 87.7 | 35.5 |
| | Rh | 2 | ZrO₂ | Cerahoneycomb | Rh | 2 | CeO₂ | Cerahoneycomb | 1:1 | 2.4 | 84.3 | 35 |
| | Rh | 2 | TiO₂ | Cerahoneycomb | Rh | 2 | CeO₂ | Cerahoneycomb | 1:1 | 2.4 | 84.2 | 34.6 |
| | Rh | 2 | Al₂O₃ | Cerahoneycomb | Rh | 2 | MCZ | Cerahoneycomb | 1:1 | 3.2 | 88.1 | 33.9 |
| | Rh | 2 | ZrO₂ | Cerahoneycomb | Rh | 2 | MCZ | Cerahoneycomb | 1:1 | 3.2 | 84.1 | 34.1 |
| | Rh | 2 | TiO₂ | Cerahoneycomb | Rh | 2 | MCZ | Cerahoneycomb | 1:1 | 3.2 | 87.1 | 33.8 |
| 12 | Rh | 2 | Al₂O₃ | Cerafoam | Rh | 2 | CeO₂ | Cerafoam | 1:1 | 2.4 | 86.6 | 34.3 |
| | Rh | 2 | Al₂O₃ | Metalfoam | Rh | 2 | CeO₂ | Metalfoam | 1:1 | 2.4 | 85.9 | 34.8 |
| 13 | Rh | 2 | Al₂O₃ | Cerahoneycomb | Rh | 2 | CeO₂ | Cerahoneycomb | 1:1 | 0.1 | 7.9 | 1.5 |
| | Rh | 2 | Al₂O₃ | Cerahoneycomb | Rh | 2 | CeO₂ | Cerahoneycomb | 1:1 | 12.0 | 62.3 | 22.1 |
| 14 | Rh | 2 | Al₂O₃ | Cerahoneycomb | Rh | 2 | CeO₂ | Cerahoneycomb | 1:7 | 2.4 | 76.5 | 34 |
| | Rh | 2 | Al₂O₃ | Cerahoneycomb | Rh | 2 | CeO₂ | Cerahoneycomb | 7:1 | 2.4 | 85.1 | 29.9 |

| | | | | | | | | | Outlet temperature 587° C. | | | |
|---|---|---|---|---|---|---|---|---|---|---|---|---|
| | | | | | | | | | S V = 25 | | S V = 35 | |
| Reaction | Catalyst (I) | | | | Catalyst (II) | | | | Conversion | H₂ + CO | Conversion | H₂ + CO |
| Example | PM | wt % | Carrier | Substrate | PM | wt % | Carrier | Substrate | rate % | % | rate % | % |
| 8 | Rh | 2 | Al₂O₃ | Cerahoneycomb | — | — | — | — | 77.1 | 28.8 | 70.5 | 26.6 |
| | Pt | 2 | Al₂O₃ | Cerahoneycomb | Pt | 2 | CeO₂ | Cerahoneycomb | 55.8 | 22.1 | 50.5 | 21.1 |
| | Ru | 2 | Al₂O₃ | Cerahoneycomb | Ru | 2 | CeO₂ | Cerahoneycomb | 69.8 | 26.6 | 66.7 | 25.5 |
| | Pd | 2 | Al₂O₃ | Cerahoneycomb | Pd | 2 | CeO₂ | Cerahoneycomb | 60.6 | 21.1 | 55.5 | 20.3 |
| 9 | Rh | 0.1 | Al₂O₃ | Cerahoneycomb | Rh | 2 | CeO₂ | Cerahoneycomb | 59.9 | 19.9 | 55 | 18.9 |
| | Rh | 10 | Al₂O₃ | Cerahoneycomb | Rh | 2 | CeO₂ | Cerahoneycomb | 53.2 | 20.9 | 51.1 | 19.9 |
| 10 | Rh | 2 | ZrO₂ | Cerahoneycomb | — | — | — | — | 74.1 | 26.5 | 69.9 | 23.3 |
| | Rh | 2 | TiO₂ | Cerahoneycomb | — | — | — | — | 75.1 | 26.6 | 66.3 | 22.1 |
| | Rh | 2 | CeO₂ | Cerahoneycomb | — | — | — | — | 66.3 | 30.5 | 62.3 | 30.5 |
| | Rh | 2 | MCZ | Cerahoneycomb | — | — | — | — | 65.3 | 29.1 | 61.1 | 25.5 |
| 11 | Rh | 2 | Al₂O₃ | Cerahoneycomb | Rh | 2 | CeO₂ | Cerahoneycomb | 76.5 | 32.2 | 70.8 | 31.1 |
| | Rh | 2 | ZrO₂ | Cerahoneycomb | Rh | 2 | CeO₂ | Cerahoneycomb | 74.6 | 31.9 | 70.9 | 30.5 |
| | Rh | 2 | TiO₂ | Cerahoneycomb | Rh | 2 | CeO₂ | Cerahoneycomb | 74.1 | 30.5 | 69.1 | 28.9 |
| | Rh | 2 | Al₂O₃ | Cerahoneycomb | Rh | 2 | MCZ | Cerahoneycomb | 76.1 | 31.8 | 70.8 | 30.5 |
| | Rh | 2 | ZrO₂ | Cerahoneycomb | Rh | 2 | MCZ | Cerahoneycomb | 75.9 | 31.1 | 73.1 | 28.8 |
| | Rh | 2 | TiO₂ | Cerahoneycomb | Rh | 2 | MCZ | Cerahoneycomb | 73.9 | 29.8 | 68.5 | 27.7 |
| 12 | Rh | 2 | Al₂O₃ | Cerafoam | Rh | 2 | CeO₂ | Cerafoam | 73.1 | 31.9 | 68.8 | 29.9 |
| | Rh | 2 | Al₂O₃ | Metalfoam | Rh | 2 | CeO₂ | Metalfoam | 73.4 | 31.8 | 69.9 | 30.8 |
| 13 | Rh | 2 | Al₂O₃ | Cerahoneycomb | Rh | 2 | CeO₂ | Cerahoneycomb | 6.5 | 1.1 | 4 | 1.1 |
| | Rh | 2 | Al₂O₃ | Cerahoneycomb | Rh | 2 | CeO₂ | Cerahoneycomb | 65.6 | 23.1 | 70.7 | 22.2 |
| 14 | Rh | 2 | Al₂O₃ | Cerahoneycomb | Rh | 2 | CeO₂ | Cerahoneycomb | 66.1 | 29.9 | 61.1 | 30.1 |
| | Rh | 2 | Al₂O₃ | Cerahoneycomb | Rh | 2 | CeO₂ | Cerahoneycomb | 76.1 | 28.1 | 69.9 | 26 |

TABLE 3

| | | | | | | | | | Surface | | | |
|---|---|---|---|---|---|---|---|---|---|---|---|---|
| | | | | | | | | | layer/ | | Outlet temperature 587° C. | |
| | | | | | | | | | inner | Amount of | S V = 15 | |
| Reaction | Surface layer catalyst | | | | Inner layer catalyst | | | | layer | noble metal | Conversion | H₂ + CO |
| Example | PM | wt % | Carrier | Substrate | PM | wt % | Carrier | Substrate | ratio | (g) | rate % | % |
| 15 | Rh | 2 | Al₂O₃ | Cerahoneycomb | — | — | — | — | 1:0 | 2.4 | 88.1 | 31 |
| | Pt | 2 | Al₂O₃ | Cerahoneycomb | Pt | 2 | CeO₂ | Cerahoneycomb | 1:1 | 2.4 | 68 | 24 |
| | Ru | 2 | Al₂O₃ | Cerahoneycomb | Ru | 2 | CeO₂ | Cerahoneycomb | 1:1 | 2.4 | 74.1 | 26.2 |
| | Pd | 2 | Al₂O₃ | Cerahoneycomb | Pd | 2 | CeO₂ | Cerahoneycomb | 1:1 | 2.4 | 72.3 | 26.6 |
| 16 | Rh | 0.1 | Al₂O₃ | Cerahoneycomb | Rh | 2 | CeO₂ | Cerahoneycomb | 1:1 | 1.32 | 67.1 | 29.8 |
| | Rh | 10 | Al₂O₃ | Cerahoneycomb | Rh | 2 | CeO₂ | Cerahoneycomb | 1:1 | 13.2 | 59.4 | 27.5 |
| 17 | Rh | 2 | ZrO₂ | Cerahoneycomb | — | — | — | — | 1:0 | 2.4 | 84.8 | 28.5 |
| | Rh | 2 | TiO₂ | Cerahoneycomb | — | — | — | — | 1:0 | 2.4 | 84.8 | 29 |
| | Rh | 2 | CeO₂ | Cerahoneycomb | — | — | — | — | 1:0 | 2.4 | 77.3 | 34.6 |
| | Rh | 2 | MCZ | Cerahoneycomb | — | — | — | — | 1:0 | 4.0 | 76.8 | 33.9 |
| 18 | Rh | 2 | Al₂O₃ | Cerahoneycomb | Rh | 2 | CeO₂ | Cerahoneycomb | 1:1 | 2.4 | 90.1 | 35.8 |
| | Rh | 2 | ZrO₂ | Cerahoneycomb | Rh | 2 | CeO₂ | Cerahoneycomb | 1:1 | 2.4 | 84 | 34.9 |
| | Rh | 2 | TiO₂ | Cerahoneycomb | Rh | 2 | CeO₂ | Cerahoneycomb | 1:1 | 2.4 | 83.9 | 34.9 |
| | Rh | 2 | Al₂O₃ | Cerahoneycomb | Rh | 2 | MCZ | Cerahoneycomb | 1:1 | 3.2 | 89.4 | 34.1 |
| | Rh | 2 | ZrO₂ | Cerahoneycomb | Rh | 2 | MCZ | Cerahoneycomb | 1:1 | 3.2 | 83.9 | 33.5 |
| | Rh | 2 | TiO₂ | Cerahoneycomb | Rh | 2 | MCZ | Cerahoneycomb | 1:1 | 3.2 | 86.9 | 33.4 |
| 19 | Rh | 2 | Al₂O₃ | Cerafoam | Rh | 2 | CeO₂ | Cerafoam | 1:1 | 2.4 | 86.3 | 35 |
| | Rh | 2 | Al₂O₃ | Metalfoam | Rh | 2 | CeO₂ | Metalfoam | 1:1 | 2.4 | 87.8 | 35.1 |
| 20 | Rh | 2 | Al₂O₃ | Cerahoneycomb | Rh | 2 | CeO₂ | Cerahoneycomb | 1:1 | 0.1 | 8.8 | 3.5 |
| | Rh | 2 | Al₂O₃ | Cerahoneycomb | Rh | 2 | CeO₂ | Cerahoneycomb | 1:1 | 12.0 | 64.1 | 23.3 |
| 21 | Rh | 2 | Al₂O₃ | Cerahoneycomb | Rh | 2 | CeO₂ | Cerahoneycomb | 1:7 | 2.4 | 76.2 | 34.7 |
| | Rh | 2 | Al₂O₃ | Cerahoneycomb | Rh | 2 | CeO₂ | Cerahoneycomb | 7:1 | 2.4 | 86.9 | 30.5 |

| | | | | | | | | | Outlet temperature 587° C. | | | |
|---|---|---|---|---|---|---|---|---|---|---|---|---|
| | | | | | | | | | S V = 25 | | S V = 35 | |
| Reaction | Surface layer catalyst | | | | Inner layer catalyst | | | | Conversion | H₂ + CO | Conversion | H₂ + CO |
| Example | PM | wt % | Carrier | Substrate | PM | wt % | Carrier | Substrate | rate % | % | rate % | % |
| 15 | Rh | 2 | Al₂O₃ | Cerahoneycomb | — | — | — | — | 77.1 | 28.8 | 70.5 | 26.6 |
| | Pt | 2 | Al₂O₃ | Cerahoneycomb | Pt | 2 | CeO₂ | Cerahoneycomb | 55.5 | 23.6 | 50.5 | 22.2 |
| | Ru | 2 | Al₂O₃ | Cerahoneycomb | Ru | 2 | CeO₂ | Cerahoneycomb | 68.8 | 25.9 | 65.5 | 25 |
| | Pd | 2 | Al₂O₃ | Cerahoneycomb | Pd | 2 | CeO₂ | Cerahoneycomb | 61.5 | 21.8 | 56.7 | 21.3 |
| 16 | Rh | 0.1 | Al₂O₃ | Cerahoneycomb | Rh | 2 | CeO₂ | Cerahoneycomb | 60.3 | 21.6 | 55 | 19.9 |
| | Rh | 10 | Al₂O₃ | Cerahoneycomb | Rh | 2 | CeO₂ | Cerahoneycomb | 55 | 22.1 | 52.4 | 20 |
| 17 | Rh | 2 | ZrO₂ | Cerahoneycomb | — | — | — | — | 74.1 | 26.5 | 69.9 | 23.3 |
| | Rh | 2 | TiO₂ | Cerahoneycomb | — | — | — | — | 75.1 | 26.6 | 66.3 | 22.1 |
| | Rh | 2 | CeO₂ | Cerahoneycomb | — | — | — | — | 66.3 | 30.5 | 62.3 | 30.5 |
| | Rh | 2 | MCZ | Cerahoneycomb | — | — | — | — | 65.3 | 29.1 | 61.1 | 25.5 |
| 18 | Rh | 2 | Al₂O₃ | Cerahoneycomb | Rh | 2 | CeO₂ | Cerahoneycomb | 77.3 | 33.3 | 71 | 32.5 |
| | Rh | 2 | ZrO₂ | Cerahoneycomb | Rh | 2 | CeO₂ | Cerahoneycomb | 75.5 | 33 | 72.1 | 31.6 |
| | Rh | 2 | TiO₂ | Cerahoneycomb | Rh | 2 | CeO₂ | Cerahoneycomb | 74.2 | 31.3 | 70.2 | 30.1 |
| | Rh | 2 | Al₂O₃ | Cerahoneycomb | Rh | 2 | MCZ | Cerahoneycomb | 76.1 | 31.8 | 71.9 | 31.6 |
| | Rh | 2 | ZrO₂ | Cerahoneycomb | Rh | 2 | MCZ | Cerahoneycomb | 75.8 | 32.2 | 72.1 | 30.3 |
| | Rh | 2 | TiO₂ | Cerahoneycomb | Rh | 2 | MCZ | Cerahoneycomb | 73.9 | 31.2 | 69.6 | 29 |
| 19 | Rh | 2 | Al₂O₃ | Cerafoam | Rh | 2 | CeO₂ | Cerafoam | 75.1 | 32.9 | 68.9 | 31.5 |
| | Rh | 2 | Al₂O₃ | Metalfoam | Rh | 2 | CeO₂ | Metalfoam | 74.9 | 32.8 | 70.1 | 31.6 |
| 20 | Rh | 2 | Al₂O₃ | Cerahoneycomb | Rh | 2 | CeO₂ | Cerahoneycomb | 7.7 | 2.2 | 3.9 | 2 |
| | Rh | 2 | Al₂O₃ | Cerahoneycomb | Rh | 2 | CeO₂ | Cerahoneycomb | 66.8 | 24.4 | 72.3 | 24.5 |
| 21 | Rh | 2 | Al₂O₃ | Cerahoneycomb | Rh | 2 | CeO₂ | Cerahoneycomb | 65.9 | 31.5 | 63.2 | 30.9 |
| | Rh | 2 | Al₂O₃ | Cerahoneycomb | Rh | 2 | CeO₂ | Cerahoneycomb | 78 | 28.2 | 70.2 | 26.5 |

TABLE 4

| | | | | | | | | | Front | | Inlet temperature | |
|---|---|---|---|---|---|---|---|---|---|---|---|---|
| | | | | | | | | | to | Amount of | 400° C. | |
| Reaction | Front section | | | | Back section | | | | back | noble metal | Conversion | (H₂ + CO)/ |
| Example | PM | wt % | Carrier | Substrate | PM | wt % | Carrier | Substrate | ratio | (g) | rate % | N₂ % |
| 22 | Rh | 2 | Al₂O₃ | Cerahoneycomb | — | — | — | — | 1:0 | 2.4 | 87 | 1.27 |
| | Rh | 2 | CeO₂ | Cerahoneycomb | — | — | — | — | 1:0 | 2.4 | 88 | 1.27 |
| 23 | Rh | 2 | Al₂O₃ | Cerahoneycomb | Rh | 2 | CeO₂ | Cerahoneycomb | 1:5 | 2.4 | 87 | 1.30 |
| | Rh | 2 | Al₂O₃ | Cerahoneycomb | Rh | 2 | CeO₂ | Cerahoneycomb | 1:2 | 2.4 | 85 | 1.29 |
| | Rh | 2 | Al₂O₃ | Cerahoneycomb | Rh | 2 | CeO₂ | Cerahoneycomb | 1:1 | 2.4 | 87 | 1.30 |
| | Rh | 2 | Al₂O₃ | Cerahoneycomb | Rh | 2 | CeO₂ | Cerahoneycomb | 2:1 | 2.4 | 88 | 1.27 |
| 24 | Rh | 2 | Al₂O₃ | Cerahoneycomb | Rh | 2 | Al₂O₃ | Cerahoneycomb | 1:1 | 2.4 | 87 | 1.25 |
| | Rh | 2 | CeO₂ | Cerahoneycomb | Rh | 2 | Al₂O₃ | Cerahoneycomb | 1:1 | 2.4 | 84 | 1.19 |

| | | | | | | | | | Inlet temperature | | | |
|---|---|---|---|---|---|---|---|---|---|---|---|---|
| | | | | | | | | | 500° C. | | 600° C. | |
| | | | | | | | | | Conver- | | Conver- | |
| Reaction | Front section | | | | Back section | | | | sion | (H₂ + CO)/ | sion | (H₂ + CO)/ |
| Example | PM | wt % | Carrier | Substrate | PM | wt % | Carrier | Substrate | rate % | N₂ % | rate % | N₂ % |
| 22 | Rh | 2 | Al₂O₃ | Cerahoneycomb | — | — | — | — | 90 | 1.33 | 94 | 1.37 |
| | Rh | 2 | CeO₂ | Cerahoneycomb | — | — | — | — | 92 | 1.31 | 93 | 1.34 |
| 23 | Rh | 2 | Al₂O₃ | Cerahoneycomb | Rh | 2 | CeO₂ | Cerahoneycomb | 89 | 1.33 | 92 | 1.32 |
| | Rh | 2 | Al₂O₃ | Cerahoneycomb | Rh | 2 | CeO₂ | Cerahoneycomb | 90 | 1.29 | 90 | 1.31 |
| | Rh | 2 | Al₂O₃ | Cerahoneycomb | Rh | 2 | CeO₂ | Cerahoneycomb | 94 | 1.38 | 95 | 1.41 |
| | Rh | 2 | Al₂O₃ | Cerahoneycomb | Rh | 2 | CeO₂ | Cerahoneycomb | 90 | 1.30 | 91 | 1.31 |
| 24 | Rh | 2 | Al₂O₃ | Cerahoneycomb | Rh | 2 | Al₂O₃ | Cerahoneycomb | 91 | 1.31 | 91 | 1.32 |
| | Rh | 2 | CeO₂ | Cerahoneycomb | Rh | 2 | Al₂O₃ | Cerahoneycomb | 91 | 1.31 | 87 | 1.21 |

| | | | | | | | | | Front | | LHSV | |
|---|---|---|---|---|---|---|---|---|---|---|---|---|
| | | | | | | | | | to | Amount of | 15 | |
| Reaction | Front section | | | | Back section | | | | back | noble metal | Conversion | (H₂ + CO)/ |
| Example | PM | wt % | Carrier | Substrate | PM | wt % | Carrier | Substrate | ratio | (g) | rate % | N₂% |
| 25 | Rh | 2 | Al₂O₃ | Cerahoneycomb | — | — | — | — | 1:0 | 2.4 | 90 | 1.25 |
| | Rh | 2 | CeO₂ | Cerahoneycomb | — | — | — | — | 1:0 | 2.4 | 90 | 1.25 |
| 26 | Rh | 2 | Al₂O₃ | Cerahoneycomb | Rh | 2 | CeO₂ | Cerahoneycomb | 1:5 | 2.4 | 89 | 1.22 |
| | Rh | 2 | Al₂O₃ | Cerahoneycomb | Rh | 2 | CeO₂ | Cerahoneycomb | 1:2 | 2.4 | 86 | 1.2 |
| | Rh | 2 | Al₂O₃ | Cerahoneycomb | Rh | 2 | CeO₂ | Cerahoneycomb | 1:1 | 2.4 | 93 | 1.29 |
| | Rh | 2 | Al₂O₃ | Cerahoneycomb | Rh | 2 | CeO₂ | Cerahoneycomb | 2:1 | 2.4 | 89 | 1.21 |
| 27 | Rh | 2 | Al₂O₃ | Cerahoneycomb | Rh | 2 | Al₂O₃ | Cerahoneycomb | 1:1 | 2.4 | 87 | 1.15 |
| | Rh | 2 | Al₂O₃ | Cerahoneycomb | Rh | 2 | Al₂O₃ | Cerahoneycomb | 1:1 | 2.4 | 86 | 1.12 |

| | | | | | | | | | LHSV | | | |
|---|---|---|---|---|---|---|---|---|---|---|---|---|
| | | | | | | | | | 25 | | 35 | |
| | | | | | | | | | Conver- | | Conver- | |
| Reaction | Front section | | | | Back section | | | | sion | (H₂+ CO)/ | sion | (H₂ + CO)/ |
| Example | PM | wt % | Carrier | Substrate | PM | wt % | Carrier | Substrate | rate % | N₂% | rate % | N₂% |
| 25 | Rh | 2 | Al₂O₃ | Cerahoneycomb | — | — | — | — | 92 | 1.33 | 89 | 1.32 |
| | Rh | 2 | CeO₂ | Cerahoneycomb | — | — | — | — | 92 | 1.31 | 89 | 1.31 |
| 26 | Rh | 2 | Al₂O₃ | Cerahoneycomb | Rh | 2 | CeO₂ | Cerahoneycomb | 89 | 1.33 | 91 | 1.36 |
| | Rh | 2 | Al₂O₃ | Cerahoneycomb | Rh | 2 | CeO₂ | Cerahoneycomb | 90 | 1.29 | 89 | 1.34 |
| | Rh | 2 | Al₂O₃ | Cerahoneycomb | Rh | 2 | CeO₂ | Cerahoneycomb | 94 | 1.38 | 92 | 1.38 |
| | Rh | 2 | Al₂O₃ | Cerahoneycomb | Rh | 2 | CeO₂ | Cerahoneycomb | 90 | 1.3 | 91 | 1.31 |
| 27 | Rh | 2 | Al₂O₃ | Cerahoneycomb | Rh | 2 | Al₂O₃ | Cerahoneycomb | 91 | 1.31 | 90 | 1.33 |
| | Rh | 2 | Al₂O₃ | Cerahoneycomb | Rh | 2 | Al₂O₃ | Cerahoneycomb | 91 | 1.31 | 89 | 1.29 |

TABLE 5

| | | | | | | | | | | | Inlet temperature | |
|---|---|---|---|---|---|---|---|---|---|---|---|---|
| | | | | | | | | | | Amount of | 400° C. | |
| Reaction | Catalyst (I) | | | | Catalyst (II) | | | | Mixing | noble metal | Conversion | (H₂ + CO)/ |
| Example | PM | wt % | Carrier | Substrate | PM | wt % | Carrier | Substrate | ratio | (g) | rate % | N₂ % |
| 28 | Rh | 2 | Al₂O₃ | Cerahoneycomb | Rh | 2 | CeO₂ | Cerahoneycomb | 1:6 | 2.4 | 84 | 1.22 |
| | Rh | 2 | Al₂O₃ | Cerahoneycomb | Rh | 2 | CeO₂ | Cerahoneycomb | 1:2 | 2.4 | 88 | 1.25 |
| | Rh | 2 | Al₂O₃ | Cerahoneycomb | Rh | 2 | CeO₂ | Cerahoneycomb | 1:1 | 2.4 | 90 | 1.25 |
| | Rh | 2 | Al₂O₃ | Cerahoneycomb | Rh | 2 | CeO₂ | Cerahoneycomb | 2:1 | 2.4 | 83 | 1.21 |
| | Rh | 2 | Al₂O₃ | Cerahoneycomb | Rh | 2 | CeO₂ | Cerahoneycomb | 6:1 | 2.4 | 85 | 1.22 |

| | | | | | | | | | Inlet temperature | | | |
|---|---|---|---|---|---|---|---|---|---|---|---|---|
| | | | | | | | | | 500° C. | | 600° C. | |
| | | | | | | | | | Conver- | | Conver- | |
| Reaction | Catalyst (I) | | | | Catalyst (II) | | | | sion | (H₂ + CO)/ | sion | (H₂ + CO)/ |
| Example | PM | wt % | Carrier | Substrate | PM | wt % | Carrier | Substrate | rate % | N₂ % | rate % | N₂ % |
| 28 | Rh | 2 | Al₂O₃ | Cerahoneycomb | Rh | 2 | CeO₂ | Cerahoneycomb | 88 | 1.27 | 90 | 1.31 |
| | Rh | 2 | Al₂O₃ | Cerahoneycomb | Rh | 2 | CeO₂ | Cerahoneycomb | 93 | 1.30 | 94 | 1.32 |
| | Rh | 2 | Al₂O₃ | Cerahoneycomb | Rh | 2 | CeO₂ | Cerahoneycomb | 93 | 1.33 | 94 | 1.36 |
| | Rh | 2 | Al₂O₃ | Cerahoneycomb | Rh | 2 | CeO₂ | Cerahoneycomb | 89 | 1.25 | 90 | 1.26 |
| | Rh | 2 | Al₂O₃ | Cerahoneycomb | Rh | 2 | CeO₂ | Cerahoneycomb | 88 | 1.28 | 89 | 1.28 |

| | | | | | | | | | | | LHSV | |
|---|---|---|---|---|---|---|---|---|---|---|---|---|
| | | | | | | | | | | Amount of | 15 | |
| Reaction | Catalyst (I) | | | | Catalyst (II) | | | | Mixing | noble metal | Conversion | (H₂ + CO)/ |
| Example | PM | wt % | Carrier | Substrate | PM | wt % | Carrier | Substrate | ratio | (g) | rate % | N₂ % |
| 29 | Rh | 2 | Al₂O₃ | Cerahoneycomb | Rh | 2 | CeO₂ | Cerahoneycomb | 1:6 | 2.4 | 89 | 1.21 |
| | Rh | 2 | Al₂O₃ | Cerahoneycomb | Rh | 2 | CeO₂ | Cerahoneycomb | 1:2 | 2.4 | 93 | 1.19 |
| | Rh | 2 | Al₂O₃ | Cerahoneycomb | Rh | 2 | CeO₂ | Cerahoneycomb | 1:1 | 2.4 | 93 | 1.20 |
| | Rh | 2 | Al₂O₃ | Cerahoneycomb | Rh | 2 | CeO₂ | Qerahoneycomb | 2:1 | 2.4 | 90 | 1.17 |
| | Rh | 2 | Al₂O₃ | Cerahoneycomb | Rh | 2 | CeO₂ | Cerahoneycomb | 6:1 | 2.4 | 86 | 1.15 |

| | | | | | | | | | LHSV | | | |
|---|---|---|---|---|---|---|---|---|---|---|---|---|
| | | | | | | | | | 25 | | 35 | |
| | | | | | | | | | Conver- | | Conver- | |
| Reaction | Catalyst (I) | | | | Catalyst (II) | | | | sion | (H₂ + CO)/ | sion | (H₂ + CO)/ |
| Example | PM | wt % | Carrier | Substrate | PM | wt % | Carrier | Substrate | rate % | N₂ % | rate % | N₂ % |
| 29 | Rh | 2 | Al₂O₃ | Cerahoneycomb | Rh | 2 | CeO₂ | Cerahoneycomb | 88 | 1.27 | 86 | 1.28 |
| | Rh | 2 | Al₂O₃ | Cerahoneycomb | Rh | 2 | CeO₂ | Cerahoneycomb | 93 | 1.30 | 90 | 1.31 |
| | Rh | 2 | Al₂O₃ | Cerahoneycomb | Rh | 2 | CeO₂ | Cerahoneycomb | 93 | 1.33 | 91 | 1.31 |
| | Rh | 2 | Al₂O₃ | Cerahoneycomb | Rh | 2 | CeO₂ | Qerahoneycomb | 89 | 1.25 | 87 | 1.25 |
| | Rh | 2 | Al₂O₃ | Cerahoneycomb | Rh | 2 | CeO₂ | Cerahoneycomb | 88 | 1.28 | 87 | 1.29 |

TABLE 6

| | | | | | | | | | Surface | | | |
|---|---|---|---|---|---|---|---|---|---|---|---|---|
| | | | | | | | | | layer/ | | Inlet temperature | |
| | | | | | | | | | inner | Amount of | 400° C. | |
| Reaction | Surface layer catalyst | | | | Inner layer catalyst | | | | layer | noble metal | Conversion | (H₂ + CO)/ |
| Example | PM | wt % | Carrier | Substrate | PM | wt % | Carrier | Substrate | ratio | (g) | rate % | N₂ % |
| 30 | Rh | 2 | Al₂O₃ | Cerahoneycomb | Rh | 2 | CeO₂ | Cerahoneycomb | 1:6 | 2.4 | 88 | 1.26 |
| | Rh | 2 | Al₂O₃ | Cerahoneycomb | Rh | 2 | CeO₂ | Cerahoneycomb | 1:2 | 2.4 | 85 | 1.24 |
| | Rh | 2 | Al₂O₃ | Cerahoneycomb | Rh | 2 | CeO₂ | Cerahoneycomb | 1:1 | 2.4 | 86 | 1.26 |
| | Rh | 2 | Al₂O₃ | Cerahoneycomb | Rh | 2 | CeO₂ | Cerahoneycomb | 2:1 | 2.4 | 84 | 1.20 |
| | Rh | 2 | Al₂O₃ | Cerahoneycomb | Rh | 2 | CeO₂ | Cerahoneycomb | 6:1 | 2.4 | 82 | 1.21 |

| | | | | | | | | | Inlet temperature | | | |
|---|---|---|---|---|---|---|---|---|---|---|---|---|
| | | | | | | | | | 500° C. | | 600° C. | |
| | | | | | | | | | Conver- | | Conver- | |
| Reaction | Surface layer catalyst | | | | Inner layer catalyst | | | | sion | (H₂ + CO)/ | sion | (H₂ + CO)/ |
| Example | PM | wt % | Carrier | Substrate | PM | wt % | Carrier | Substrate | rate % | N₂ % | rate % | N₂ % |
| 30 | Rh | 2 | Al₂O₃ | Cerahoneycomb | Rh | 2 | CeO₂ | Cerahoneycomb | 91 | 1.32 | 90 | 1.30 |
| | Rh | 2 | Al₂O₃ | Cerahoneycomb | Rh | 2 | CeO₂ | Cerahoneycomb | 90 | 1.31 | 91 | 1.33 |
| | Rh | 2 | Al₂O₃ | Cerahoneycomb | Rh | 2 | CeO₂ | Cerahoneycomb | 90 | 1.31 | 93 | 1.36 |
| | Rh | 2 | Al₂O₃ | Cerahoneycomb | Rh | 2 | CeO₂ | Cerahoneycomb | 90 | 1.30 | 91 | 1.32 |
| | Rh | 2 | Al₂O₃ | Cerahoneycomb | Rh | 2 | CeO₂ | Cerahoneycomb | 88 | 1.25 | 90 | 1.30 |

| | | | | | | | | | Surface | | | |
|---|---|---|---|---|---|---|---|---|---|---|---|---|
| | | | | | | | | | layer/ | | LHSV | |
| | | | | | | | | | inner | Amount of | 15 | |
| Reaction | Surface layer catalyst | | | | Inner layer catalyst | | | | layer | noble metal | Conversion | (H2 + CO)/ |
| Example | PM | wt % | Carrier | Substrate | PM | wt % | Carrier | Substrate | ratio | (g) | rate % | N₂ % |
| 31 | Rh | 2 | Al₂O₃ | Cerahoneycomb | Rh | 2 | CeO₂ | Cerahoneycomb | 1:6 | 2.4 | 93 | 1.23 |
| | Rh | 2 | Al₂O₃ | Cerahoneycomb | Rh | 2 | CeO₂ | Cerahoneycomb | 1:2 | 2.4 | 91 | 1.23 |
| | Rh | 2 | Al₂O₃ | Cerahoneycomb | Rh | 2 | CeO₂ | Cerahoneycomb | 1:1 | 2.4 | 90 | 1.23 |
| | Rh | 2 | Al₂O₃ | Cerahoneycomb | Rh | 2 | CeO₂ | Cerahoneycomb | 2:1 | 2.4 | 90 | 1.20 |
| | Rh | 2 | Al₂O₃ | Cerahoneycomb | Rh | 2 | CeO₂ | Cerahoneycomb | 6:1 | 2.4 | 89 | 1.20 |

| | | | | | | | | | LHSV | | | |
|---|---|---|---|---|---|---|---|---|---|---|---|---|
| | | | | | | | | | 25 | | 35 | |
| | | | | | | | | | Conver- | | Conver- | |
| Reaction | Surface layer catalyst | | | | Inner layer catalyst | | | | sion | (H₂ + CO)/ | sion | (H₂ + CO)/ |
| Example | PM | wt % | Carrier | Substrate | PM | wt % | Carrier | Substrate | rate % | N₂ % | rate % | N₂ % |
| 31 | Rh | 2 | Al₂O₃ | Cerahoneycomb | Rh | 2 | CeO₂ | Cerahoneycomb | 91 | 1.32 | 90 | 1.30 |
| | Rh | 2 | Al₂O₃ | Cerahoneycomb | Rh | 2 | CeO₂ | Cerahoneycomb | 90 | 1.31 | 89 | 1.32 |
| | Rh | 2 | Al₂O₃ | Cerahoneycomb | Rh | 2 | CeO₂ | Cerahoneycomb | 90 | 1.31 | 89 | 1.33 |
| | Rh | 2 | Al₂O₃ | Cerahoneycomb | Rh | 2 | CeO₂ | Cerahoneycomb | 90 | 1.30 | 91 | 1.32 |
| | Rh | 2 | Al₂O₃ | Cerahoneycomb | Rh | 2 | CeO₂ | Cerahoneycomb | 88 | 1.25 | 85 | 1.26 |

1. A fuel reforming apparatus comprising:
a catalyst packed portion containing therein a first fuel reforming catalyst (I) having excellent hydrocarbon conversion rate and a second fuel reforming catalyst (II) having excellent H₂+CO formation rate.

2. A fuel reforming apparatus according to claim 1,
wherein the first fuel reforming catalyst (I) has a higher hydrocarbon conversion rate at an operating temperature than that of the second fuel reforming catalyst (II), and
the second fuel reforming catalyst (II) has a higher H₂+CO formation rate at an operating temperature than that of the first fuel reforming catalyst (I).

3. A fuel reforming apparatus according to claim 1,
wherein the first fuel reforming catalyst (I) has at least one first oxide carrier selected from a group consisting of aluminum oxide, zirconium oxide, and titanium oxide, and a noble metal supported on the first oxide carrier, and
the second fuel reforming catalyst (II) has a second oxide carrier including cerium oxide, and a noble metal supported on the second oxide carrier.

4. A fuel reforming apparatus according to claim 1,
wherein the first fuel reforming catalyst (I) is contained in a front section of the catalyst packed portion, and the second fuel reforming catalyst (II) is contained in a back section of the catalyst packed portion.

5. A fuel reforming apparatus according to claim 1,
wherein the first fuel reforming catalyst (I) and the second fuel reforming catalyst (II) are contained in the catalyst packed portion in the form of a mixture of catalysts (I) and (II).

6. A fuel reforming apparatus according to claim 1,
wherein the first fuel reforming catalyst (I) and the second fuel reforming catalyst (II) are contained in the catalyst packed portion in the form of a stacked body including a first layer having the first fuel reforming catalyst (I) and a second layer having the second fuel reforming catalyst (II).

7. A fuel reforming apparatus according to claim 6,
wherein the first layer constitutes a surface layer and the second layer constitutes an inner layer.

8. A fuel reforming apparatus according to claim 1,
wherein each of the first fuel reforming catalyst and the second fuel reforming catalyst comprises at least one noble metal element selected from a group consisting of platinum, rhodium, palladium, and ruthenium and a carrier having the noble metal supported thereon.

9. A fuel reforming apparatus according to claim 8,
wherein the noble metal element is rhodium.

10. A fuel reforming apparatus according to claim 8,
wherein the amount of the noble metal element supported is 0.1 to 10% by mass per catalyst in terms of a metal.

11. A fuel reforming apparatus according to claim 8,
wherein the carrier for the first fuel reforming catalyst (I) is at least one oxide selected from a group consisting of aluminum oxide, zirconium oxide, and titanium oxide.

12. A fuel reforming apparatus according to claim 8,
wherein the carrier for the second fuel reforming catalyst (II) is at least one oxide selected from a group consisting of cerium oxide and cerium-zirconium composite oxide.

13. A fuel reforming apparatus according to claim 8,
wherein the carrier for the first fuel reforming catalyst (I) is aluminum oxide, and the carrier for the second fuel reforming catalyst (II) is cerium oxide.

14. A fuel reforming apparatus according to claim 1,
wherein the catalyst packed portion further has a honeycomb substrate or a porous substrate, and
the first fuel reforming catalyst (I) and the second fuel reforming catalyst (II) are supported on the honeycomb substrate or porous substrate.

15. A fuel reforming apparatus according to claim 14,
wherein the honeycomb substrate or porous substrate is formed from ceramic or metal.

16. A fuel reforming apparatus according to claim 1,
wherein the first fuel reforming catalyst (I) to second fuel reforming catalyst (II) mass ratio in the catalyst packed portion is 1:7 to 7:1.

17. A fuel reforming apparatus according to claim 8,
wherein the total amount of the noble metals in the catalyst packed portion is 0.1 to 12 g per one liter of the catalyst packed portion.

18. A fuel cell system, comprising:
a fuel reforming apparatus according to claim 1;
a shift reactor for reducing carbon monoxide contained in the discharged gas from the fuel reforming apparatus through a water-gas-shift reaction;
a carbon monoxide removing apparatus for removing carbon monoxide contained in the discharged gas from the shift reactor; and
a fuel cell.

19. A fuel reforming-type hydrogen generating system having mounted thereon a fuel reforming apparatus according to claim 1.

20. An vehicle having mounted thereon the fuel cell system according to claim 18.
